(19) United States
(12) Patent Application Publication
(10) Pub. No.: US 2023/0324738 A1
(43) Pub. Date: Oct. 12, 2023

(54) WAVELENGTH CONVERSION MEMBER, LIGHT EMITTING DEVICE, AND LIQUID CRYSTAL DISPLAY DEVICE

(71) Applicant: FUJIFILM Corporation, Tokyo (JP)

(72) Inventor: Tatsuya OBA, Kanagawa (JP)

(73) Assignee: FUJIFILM Corporation, Tokyo (JP)

(21) Appl. No.: 18/334,857

(22) Filed: Jun. 14, 2023

Related U.S. Application Data
(63) Continuation of application No. PCT/JP2021/046727, filed on Dec. 17, 2021.

(30) Foreign Application Priority Data
Dec. 17, 2020 (JP) 2020-209462

(51) Int. Cl. G02F 1/1335

(52) U.S. Cl. CPC G02F 1/133614; G02F 1/133621

(57) ABSTRACT

Provided is a wavelength conversion member including a wavelength conversion layer and a substrate, in which the wavelength conversion layer contains a pyrromethene derivative, a binder, and a light scattering particle.

### CROSS-REFERENCE TO RELATED APPLICATIONS

This application is a Continuation of PCT International Application No. PCT/JP2021/046727 filed on Dec. 17, 2021, which claims priority under 35 U.S.C. § 119(a) to Japanese Patent Application No. 2020-209462 filed on Dec. 17, 2020. Each of the above applications is hereby expressly incorporated by reference, in its entirety, into the present application.

### BACKGROUND OF THE INVENTION

### 1. Field of the Invention

The present invention relates to a wavelength conversion member, a light emitting device, and a liquid crystal display device.

### 2. Description of the Related Art

A flat panel display such as a liquid crystal display device (hereinafter, also referred to as LCD) is used as a space-saving image display apparatus with low power consumption, and its application is expanding year by year. The liquid crystal display device is usually composed of at least a light emitting device and a liquid crystal cell.

In recent years, improvement in color reproducibility by means of wavelength conversion has been actively studied for flat panel displays. In order to improve the color reproducibility, it is effective to narrow a half-width of each of blue, green, and red emission spectra of a backlight unit to increase the color purity of each color of blue, green, and red. This makes it possible for the obtained white light to have high brightness. Examples of means for achieving such a purpose include quantum dots made of inorganic semiconductor fine particles (see, for example, JP2013-544018A) and organic light emitting materials (see, for example, WO2016/190283A and WO2018/221216A).

### SUMMARY OF THE INVENTION

WO2018/221216A discloses that, in a case where a pyrromethene derivative is used as an organic light emitting material, higher color purity can be obtained by containing a red light emitting material and a green light emitting material in different layers to form a laminate than by containing the red light emitting material and the green light emitting material in the same layer. However, in order to prepare such a laminate, a complicated process was required, such as separately preparing a layer containing a red light emitting material and a layer containing a green light emitting material and then bonding the two layers to each other, for the purpose of preventing the organic light emitting materials from being mixed with each other.

An object of one aspect of the present invention is to provide a wavelength conversion member that has favorable brightness of white light due to high color purity and can be formed without laminating a plurality of wavelength conversion layers, and a light emitting device and a liquid crystal display device, each of which uses such a wavelength conversion member.

One aspect of the present invention relates to a wavelength conversion member including a wavelength conversion layer and a substrate, in which the wavelength conversion layer contains a pyrromethene derivative, a binder, and a light scattering particle.

WO2018/221216A discloses an example of an absorption spectrum of a red light emitting material, and it is presumed that the absorbance in a blue region is low, and a light emission amount of red fluorescence is insufficient with only blue light. The present inventors have newly found that a light emission amount (for example, a red light emission amount) can be increased by including light scattering particles in a wavelength conversion layer containing a pyrromethene derivative, which makes it possible to maintain the color purity even in a case where materials having different luminescence wavelength ranges are mixed in the same layer.

In addition, one aspect of the present invention relates to a wavelength conversion member including a wavelength conversion layer and a substrate, in which the wavelength conversion layer contains a pyrromethene derivative, and a haze of the wavelength conversion member is 80% or more and 99.5% or less.

In addition, one aspect of the present invention relates to a wavelength conversion member including a wavelength conversion layer and a substrate, in which the wavelength conversion layer contains a pyrromethene derivative, an outside haze of the substrate is 0.5% or more and 50% or less, and an inside haze of the wavelength conversion member is 30% or more.

In one embodiment, the inside haze of the wavelength conversion member and the outside haze of the substrate can satisfy a relationship of inside haze≥outside haze.

In one embodiment, a diameter R of the light scattering particle can be 0.1 μm or more.

In one embodiment, the wavelength conversion member can contain, in the same wavelength conversion layer, a pyrromethene derivative exhibiting light emission by using excitation light, in which a peak wavelength is observed in a region of 500 nm or more and 580 nm or less, and a pyrromethene derivative exhibiting light emission by using excitation light, in which a peak wavelength is observed in a region of 580 nm or more and 750 nm or less.

One aspect of the present invention relates to a light emitting device including the wavelength conversion member and a light source.

In one embodiment, the light source can be selected from the group consisting of a blue light emitting diode and an ultraviolet light emitting diode.

One aspect of the present invention relates to a liquid crystal display device including the light emitting device and a liquid crystal cell.

According to one aspect of the present invention, it is possible to provide a wavelength conversion member that has favorable brightness of white light by increasing the color purity and can be formed without laminating a plurality of wavelength conversion layers. According to another aspect of the present invention, it is possible to provide a light emitting device including the wavelength conversion member, and a liquid crystal display device including the light emitting device.

### BRIEF DESCRIPTION OF THE DRAWINGS

FIG. 1 is a schematic diagram of a backlight unit 10 which is a so-called direct type backlight unit.

FIG. 2 is a configuration diagram of a wavelength conversion member 16 having a configuration in which a wavelength conversion layer 21 is sandwiched between substrates 22 corresponding to both main surfaces of the wavelength conversion layer 21.

### DESCRIPTION OF THE PREFERRED EMBODIMENTS

The following description may be based on representative embodiments of the present invention. However, the present invention is not limited to such embodiments. In the present invention and the present specification, any numerical range expressed by using “to” refers to a range including the numerical values before and after the “to” as a lower limit value and an upper limit value, respectively.

In addition, in the present specification, “(meth)acrylate” is used to indicate at least one or both of acrylate and methacrylate. The same applies to “(meth)acryloyl” and the like.

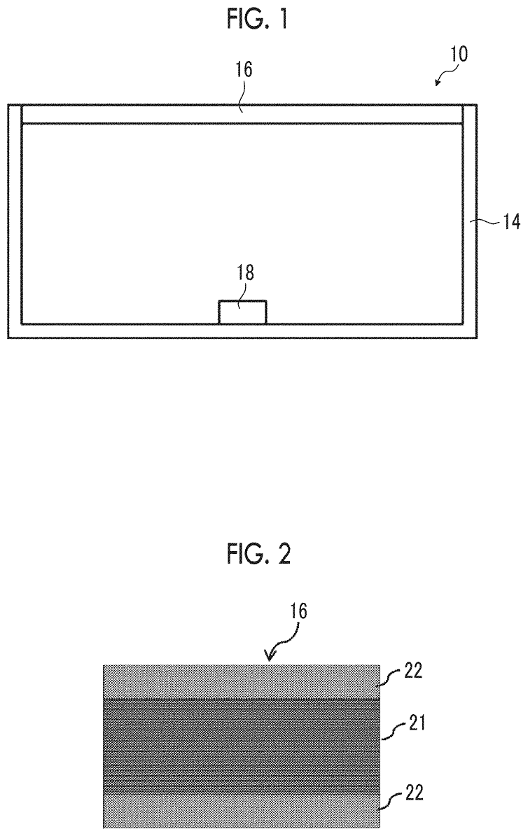

FIG. 1 conceptually shows an example of a backlight unit using the wavelength conversion member according to one aspect of the present invention.

A backlight unit 10 is a direct type planar backlight unit (planar lighting device) used for a backlight of a liquid crystal display device or the like, and is configured to have a housing 14, a wavelength conversion member 16, and a light source 18. The wavelength conversion member 16 is a wavelength conversion member according to one aspect of the present invention.

In the following description, the “liquid crystal display device” is also referred to as “LCD”. It should be noted that “LCD” is an abbreviation for “Liquid Crystal Display”.

In addition, FIG. 1 is merely a schematic diagram, and the backlight unit 10 may have various known members provided in a known backlight unit such as a backlight of an LCD, for example, one or more of a light emitting diode (LED) substrate, a wiring line, and a heat radiation mechanism, in addition to the illustrated members.

The housing 14 is, for example, a rectangular housing whose maximum surface is open, and the wavelength conversion member 16 is disposed to close the opening surface. The housing 14 is a known housing used for a backlight unit of an LCD or the like.

In addition, as a preferred form, at least a bottom surface of the housing 14, which is an installation surface of the light source 18, is a light reflecting surface selected from a mirror surface, a metal reflecting surface, a diffuse reflecting surface, and the like. Preferably, the entire inner surface of the housing 14 is a light reflecting surface.

The wavelength conversion member 16 is a wavelength conversion member that receives light emitted from the light source 18, converts the wavelength of the light, and emits the wavelength-converted light. As described above, the wavelength conversion member 16 is a wavelength conversion member according to one aspect of the present invention. The wavelength conversion member 16 has at least a wavelength conversion layer and a substrate. The substrate can support the wavelength conversion layer.

<Wavelength Conversion Layer>

The wavelength conversion layer has a function of converting the wavelength of the incident light and emitting the wavelength-converted light. For example, in a case where blue light emitted from a light source is incident on a wavelength conversion layer, the wavelength conversion layer 21 carries out wavelength conversion of at least a part of the blue light into red light or green light due to the effect of the pyrromethene derivative contained inside the wavelength conversion layer 21 and emits the wavelength-converted light. Here, the blue light is light having a light emission center wavelength in a wavelength range of 400 to 500 nm. The green light is light having a light emission center wavelength in a wavelength range of more than 500 nm and 580 nm or less. The red light is light having a light emission center wavelength in a wavelength range of more than 580 nm and 750 nm or less.

For example, in a case where blue light is incident as excitation light, white light can be realized by green light and red light emitted from the wavelength conversion layer and blue light transmitted through the wavelength conversion layer.

The shape of the wavelength conversion layer is not particularly limited and may be any shape such as a sheet shape or a bar shape.

The film thickness of the wavelength conversion layer is not particularly limited and may be appropriately set depending on the thickness of the wavelength conversion member, the pyrromethene derivative which is an organic phosphor to be used, the binder to be used, and the like.

The film thickness of the wavelength conversion layer is preferably 10 to 1,000 μm and more preferably 15 to 100 μm. Setting the film thickness of the wavelength conversion layer to 10 μm or more is preferable in terms of being capable of obtaining a wavelength conversion layer that emits light having sufficient brightness, and improving the tint distribution and the brightness distribution due to the film thickness distribution of the wavelength conversion layer.

<Light Scattering Particles>

Since a phosphor generally emits fluorescence isotropically, a portion of the fluorescence emitted within the layer of the wavelength conversion layer (hereinafter, also referred to as “light derived from the wavelength conversion layer”) undergoes total reflection at a refractive index interface, so that such a portion of the fluorescence is not taken out to an emission side and is guided inside the wavelength conversion member. It is considered that the light scattering particles disposed in the wavelength conversion layer can play a role of changing the traveling direction of the guided light that repeats the total reflection to take out the light emission to the outside of the wavelength conversion member.

The “light scattering particle” preferably refers to a particle having an average particle diameter of 0.1 μm or more, and the average particle diameter is preferably in a range of 0.5 to 15.0 μm and more preferably in a range of 0.7 to 12.0 μm from the viewpoint of the scattering effect. The “diameter R” described above has the same meaning as the average particle diameter.

In the present invention and the present specification, unless otherwise specified, the “average particle diameter” of the light scattering particle is a value obtained by the following method. Hereinafter, the particles before being used for preparing a composition for forming a wavelength conversion layer are referred to as “powder”.

The particles to be measured are observed with a scanning electron microscope (SEM) and imaged at a magnification of 1,000 to 20,000. The powder is observed for particles present as a powder. For particles contained in the composition for forming a wavelength conversion layer, which is a polymerizable composition, a cross section of a cured product obtained by curing this composition is observed. For particles in the wavelength conversion layer included in the wavelength conversion member, a cross section of the wavelength conversion layer is observed. The primary particle diameter is measured from the captured image. In addition, for particles having a non-spherical shape, an average value of a length of a major axis and a length of a minor axis is obtained, and the thus obtained value is adopted as the primary particle diameter. The particle diameter of each particle is the primary particle diameter thus obtained. In the captured image, an arithmetic average of the primary particle diameters of 20 randomly selected particles is taken as the average particle diameter. The average particle diameter of the light scattering particle shown in Examples which will be described later is a value obtained by observing and measuring a cross section of the wavelength conversion layer using S-3400N (manufactured by Hitachi High-Tech Corporation) as a scanning electron microscope.

In addition, two or more types of light scattering particles having different particle diameters may be mixed and used in order to further improve the brightness and/or adjust the distribution of the brightness with respect to the viewing angle. In a case where a particle whose particle diameter is large is referred to as a particle having a large particle diameter, and a particle whose particle diameter is smaller than that of the particle having a large particle diameter is referred to as a particle having a small particle diameter, the particle having a large particle diameter preferably has a particle diameter in a range of 5.0 μm to 15.0 μm and more preferably in a range of 6.0 μm to 12.0 μm, from the viewpoint of imparting external scattering properties and imparting anti-Newton ring properties. In addition, the particle having a small particle diameter preferably has a particle diameter in a range of 0.5 μm to 5.0 μm and more preferably in a range of 0.7 μm to 3.0 μm, from the viewpoint of imparting internal scattering properties.

The light scattering particle may be an organic particle, an inorganic particle, or an organic-inorganic composite particle. For example, a synthetic resin particle can be used as the organic particle. Specific examples of the synthetic resin particle include a silicone resin particle, an acrylic resin particle (polymethylmethacrylate (PMMA)), a nylon resin particle, a styrene resin particle, a polyethylene resin particle, a urethane resin particle, and a benzoguanamine resin particle, among which a silicone resin particle and an acrylic resin particle are preferable from the viewpoint of availability of a particle having a suitable refractive index. In addition, a particle having a hollow structure can also be used. Examples of the inorganic particle include particles of, for example, single-component metals such as tungsten, zirconium, titanium, platinum, bismuth, rhodium, palladium, silver, tin, platinum, and gold; barium sulfate; metal oxides such as silica, talc, clay, kaolin, alumina white, titanium oxide, magnesium oxide, barium oxide, aluminum oxide, bismuth oxide, zirconium oxide, and zinc oxide; metal carbonates such as magnesium carbonate, barium carbonate, bismuth subcarbonate, and calcium carbonate; metal hydroxides such as aluminum hydroxide; composite oxides such as barium zirconate, calcium zirconate, calcium titanate, barium titanate, and strontium titanate; and metal salts such as bismuth subnitrate. From the viewpoint of being more excellent in the effect of improving external quantum efficiency, the light scattering particle preferably contains at least one selected from the group consisting of titanium oxide, alumina, zirconium oxide, zinc oxide, calcium carbonate, barium sulfate, barium titanate, and silica, and more preferably contains at least one selected from the group consisting of titanium oxide, zirconium oxide, zinc oxide, and barium titanate.

The shape of the light scattering particle can be any shape such as a spherical shape, a filamentous shape, or an amorphous shape. It is preferable to use a particle having less directionality in shape (for example, a spherical particle or a regular tetrahedral particle) as the light scattering particle, from the viewpoint that the uniformity, fluidity, and light scattering properties of the composition for forming a wavelength conversion layer can be further improved.

At least a part of the surface of the inorganic particle may be covered with other components such as an inorganic substance such as alumina, silica, zinc oxide, titanium oxide, or zirconium oxide, and an organic substance such as stearic acid or polysiloxane. For example, 50 area % or more of the surface of the light scattering particle may be covered with other components, or the entire surface of the light scattering particle may be covered with other components. In this case, the light scattering particle can also be referred to as a surface-treated light scattering particle.

As a method of covering at least a part of the surface of the light scattering particle with alumina (that is, surface-treating with alumina), for example, a wet treatment method (for example, a method of adding an aluminum salt aqueous solution to a slurry of light scattering particles and neutralizing the solution to adsorb the aluminum salt on the surfaces of the light scattering particles) can be mentioned. Commercially available products such as “MPT-141”, “CR-50”, “CR-50-2”, “CR-58”, “CR-58-2”, “CR-60”, “CR-60-2”, and “CR-97” (manufactured by Ishihara Sangyo Kaisha, Ltd.), “MT-700B”, “JR-405”, “JR-603”, “JR-605”, “JR-701”, “JR-805”, and “JR-806” (manufactured by Tayca Corporation), “Ti-pure R-706” (manufactured by The Chemours Company), “ST-705SA”, “ST-710EC”, and “ST-750EC” (manufactured by Titan Kogyo, Ltd.), and “D-918” and “D-970” (manufactured by Sakai Chemical Industry Co., Ltd.) can also be used as the light scattering particle.

A large difference in refractive index between the light scattering particle and the matrix of the wavelength conversion layer is preferable from the viewpoint of the scattering effect. From this point, a refractive index difference An between the light scattering particle and the matrix is preferably 0.02 or more, more preferably 0.10 or more, and still more preferably 0.20 or more. In the present invention and the present specification, the refractive index indicates a value n_{D} measured by a D line (589 nm).

From the viewpoint of the light scattering properties of the wavelength conversion layer and the viewpoint of the brittleness of the wavelength conversion layer, the content of the light scattering particles in the wavelength conversion layer is preferably 0.5% by volume or more, more preferably 10% by volume or more and 70% by volume or less, and still more preferably 20% by volume or more and 60% by volume or less.

<Polymer Dispersant>

In order to improve the dispersion stability of the light scattering particles, the wavelength conversion member may contain a polymer dispersant in the composition for forming a wavelength conversion layer. The polymer dispersant is a polymer compound having a weight-average molecular weight of 750 or more and having a functional group with an affinity for light scattering particles. The polymer dispersant has a function of dispersing light scattering particles. The polymer dispersant is adsorbed to light scattering particles through the functional group with an affinity for light scattering particles, and the light scattering particles can be dispersed in the composition for forming a wavelength conversion layer by electrostatic repulsion and/or steric repulsion between the polymer dispersants. The polymer dispersant preferably binds to the surface of the light scattering particle to be adsorbed to the light scattering particle.

Examples of the functional group with an affinity for light scattering particles include an acidic functional group, a basic functional group, and a non-ionic functional group. The acidic functional group has a dissociative proton and may be neutralized with a base such as an amine or a hydrate ion. The basic functional group may be neutralized with an acid such as an organic acid or an inorganic acid.

Examples of the acidic functional group include a carboxy group (—COOH), a sulfo group (—SO₃H), a sulfate group (—OSO₃H), a phosphonic acid group (—PO(OH)₃), a phosphoric acid group (—OPO(OH)₃), a phosphinic acid group (—PO(OH)—), and a mercapto group (—SH).

Examples of the basic functional group include a primary amino group, a secondary amino group, a tertiary amino group, an ammonium group, an imino group, and a nitrogen-containing heterocyclic group such as pyridine, pyrimidine, pyrazine, imidazole, or triazole.

Examples of the non-ionic functional group include a hydroxy group, an ether group, a thioether group, a sulfinyl group (—SO—), a sulfonyl group (—SO₂—), a carbonyl group, a formyl group, an ester group, a carbonic acid ester group, an amide group, a carbamoyl group, a ureide group, a thioamide group, a thioureide group, a sulfamoyl group, a cyano group, an alkenyl group, an alkynyl group, a phosphine oxide group, and a phosphine sulfide group.

From the viewpoint of dispersion stability of light scattering particles, the viewpoint of not easily decreasing the quantum yield of the wavelength conversion material, the viewpoint of ease of synthesis of the polymer dispersant, and the viewpoint of stability of the functional group, the acidic functional group is preferably a carboxy group, a sulfo group, a phosphonic acid group, or a phosphoric acid group, and the basic functional group is preferably an amino group. Among these functional groups, a carboxy group, a phosphonic acid group, and an amino group are more preferable, and a carboxy group is still more preferable.

The polymer dispersant having an acidic functional group has an acid value. The acid value of the polymer dispersant having an acidic functional group is preferably 1 to 150 mgKOH/g. In a case where the acid value is 1 mgKOH/g or more, sufficient dispersibility of the light scattering particles is likely to be obtained, and in a case where the acid value is 150 mgKOH/g or less, the storage stability of the wavelength conversion layer is unlikely to decrease. The acid value of the polymer dispersant is preferably 50 mgKOH/g or less, more preferably 45 mgKOH/g or less, still more preferably 35 mgKOH/g or less, even still more preferably 30 mgKOH/g or less, and even still further preferably 24 mgKOH/g or less.

The acid value of the polymer dispersant can be obtained by the following method.

A sample solution prepared by dissolving p grams (g) of the polymer dispersant in a solution containing 50 mL of a mixed solvent in which toluene and ethanol are mixed at a volume ratio of 1:1 and 1 mL of a phenolphthalein test solution is prepared, and titrated with a 0.1 mol/L ethanolic potassium hydroxide solution (solution of 7.0 g of potassium hydroxide dissolved in 5.0 mL of distilled water and adjusted to 1,000 mL by adding 95% by volume ethanol) until the sample solution turns rose pink. Then, the acid value can be calculated by the following expression.

Acid value=q×r×5.611/p

In the expression, q represents a titration amount (mL) of the 0.1 mol/L ethanolic potassium hydroxide solution required for titration, r represents a titer of the 0.1 mol/L ethanolic potassium hydroxide solution required for titration, and p represents a mass (g) of the polymer dispersant.

The polymer dispersant having a basic functional group has an amine value. The amine value of the polymer dispersant having a basic functional group is preferably 1 to 200 mgKOH/g. In a case where the amine value is 1 mgKOH/g or more, sufficient dispersibility of the light scattering particles is likely to be obtained, and in a case where the amine value is 200 mgKOH/g or less, the storage stability of the wavelength conversion layer is unlikely to decrease. The amine value of the polymer dispersant is preferably 5 mgKOH/g or more and more preferably 10 mgKOH/g or more. The amine value of the polymer dispersant is preferably 90 mgKOH/g or less and more preferably 50 mgKOH/g or less.

The amine value of the polymer dispersant can be obtained by the following method.

A sample solution prepared by dissolving x grams (g) of the polymer dispersant in a solution containing 50 mL of a mixed solvent in which toluene and ethanol are mixed at a volume ratio of 1:1 and 1 mL of a bromophenol blue test solution is prepared, and titrated with 0.5 mol/L hydrochloric acid until the sample solution turns green. Then, the amine value can be calculated by the following expression.

Amine value=y/x×28.05

In the expression, y represents a titration amount (ml) of the 0.5 mol/L hydrochloric acid required for titration, and x represents a mass (g) of the polymer dispersant.

The polymer dispersant may be a polymer of a single polymerizable compound (homopolymer), or may be a copolymer of a plurality of types of polymerizable compounds. The polymer dispersant may be any of a random copolymer, a block copolymer, or a graft copolymer. In addition, in a case where the polymer dispersant is a graft copolymer, the graft copolymer may be a comb-shaped graft copolymer or a star-shaped graft copolymer. Examples of the polymer dispersant include an acrylic resin, a polyester resin, a polyurethane resin, a polyamide resin, a polyether resin, a phenol resin, a silicone resin, a polyurea resin, an amino resin, an epoxy resin, a polyamine resin such as polyethyleneimine or polyallylamine, and a polyimide resin.

A commercially available product can also be used as the polymer dispersant. For example, AJISPER PB series (manufactured by Ajinomoto Fine-Techno Co., Inc.), DISPERBYK series and BYK-series (manufactured by BYK-Chemie GmbH), and Efka series (manufactured by BASF SE) can be used as the commercially available product.

Examples of the commercially available product that can be used include “DISPERBYK-106”, “DISPERBYK-110”, “DISPERBYK-130”, “DISPERBYK-161”, “DISPERBYK-162”, “DISPERBYK-163”, “DISPERBYK-164”, “DISPERBYK-166”, “DISPERBYK-167”, “DISPERBYK-168”, “DISPERBYK-170”, “DISPERBYK-171”, “DISPERBYK-174”, “DISPERBYK-180”, “DISPERBYK-182”, “DISPERBYK-183”, “DISPERBYK-184”, “DISPERBYK-185”, “DISPERBYK-2000”, “DISPERBYK-2001”, “DISPERBYK-2008”, “DISPERBYK-2009”, “DISPERBYK-2020”, “DISPERBYK-2022”, “DISPERBYK-2025”, “DISPERBYK-2050”, “DISPERBYK-2070”, “DISPERBYK-2096”, “DISPERBYK-2150”, “DISPERBYK-2155”, “DISPERBYK-2163”, “DISPERBYK-2164”, “BYK-LPN21116”, and “BYK-LPN6919” (manufactured by BYK-Chemie GmbH); “EFKA4010”, “EFKA4015”, “EFKA4046”, “EFKA4047”, “EFKA4061”, “EFKA4080”, “EFKA4300”, “EFKA4310”, “EFKA4320”, “EFKA4330”, “EFKA4340”, “EFKA4560”, “EFKA4585”, “EFKA5207”, “EFKA1501”, “EFKA1502”, “EFKA1503”, and “EFKA PX-4701” (manufactured by BASF SE); “SOLSPERSE 3000”, “SOLSPERSE 9000”, “SOLSPERSE 13240”, “SOLSPERSE 13650”, “SOLSPERSE 13940”, “SOLSPERSE 11200”, “SOLSPERSE 13940”, “SOLSPERSE 16000”, “SOLSPERSE 17000”, “SOLSPERSE 18000”, “SOLSPERSE 20000”, “SOLSPERSE 21000”, “SOLSPERSE 24000”, “SOLSPERSE 26000”, “SOLSPERSE 27000”, “SOLSPERSE 28000”, “SOLSPERSE 32000”, “SOLSPERSE 32500”, “SOLSPERSE 32550”, “SOLSPERSE 32600”, “SOLSPERSE 33000”, “SOLSPERSE 34750”, “SOLSPERSE 35100”, “SOLSPERSE 35200”, “SOLSPERSE 36000”, “SOLSPERSE 37500”, “SOLSPERSE 38500”, “SOLSPERSE 39000”, “SOLSPERSE 41000”, “SOLSPERSE 54000”, “SOLSPERSE 71000”, and “SOLSPERSE 76500” (manufactured by The Lubrizol Corporation); “AJISPER PB821”, “AJISPER PB822”, “AJISPER PB881”, “AJISPER PN411”, and “AJISPER PA111” (manufactured by Ajinomoto Fine-Techno Co., Inc.); “TEGO Dispers 650”, “TEGO Dispers 660C”, “TEGO Dispers 662C”, “TEGO Dispers 670”, “TEGO Dispers 685”, “TEGO Dispers 700”, “TEGO Dispers 710”, and “TEGO Dispers 760W” (manufactured by Evonik Industries AG); and “DISPARLON DA-703-50”, “DISPARLON DA-705”, and “DISPARLON DA-725” (manufactured by Kusumoto Chemicals, Ltd.).

<Haze of Wavelength Conversion Member>

In the present invention and the present specification, the haze of the wavelength conversion member is a value measured in accordance with JIS K 7136:2000. An example of the measuring device is a haze meter NDH2000 (manufactured by Nippon Denshoku Industries Co., Ltd.).

From the viewpoint of increasing the amount of emitted light, it is desirable that the haze is high, and the haze is suitably 30% or more, preferably 80% or more, more preferably 90% or more, and still more preferably 90% to 99.8%. From the viewpoint of suppressing a decrease in light transmittance, the haze is preferably 98% or less.

<Inside Haze of Wavelength Conversion Member, and Outside Haze of Substrate>

In the present invention and the present specification, the inside haze of the wavelength conversion member indicates the haze generated by the sample internal member excluding the influence of the substrate surface haze, and is specifically obtained by the following measurement method.

First, a few drops of glycerin are added dropwise onto both surfaces of the wavelength conversion member, and the wavelength conversion member is sandwiched between two glass plates having a thickness of 1 mm (microslide glass product number: S 9111, manufactured by Matsunami Glass Ind., Ltd.) from both sides. The wavelength conversion member having both sides sandwiched between the glass plates in this manner is optically completely brought into close contact with the two glass plates, and in this state, the haze measurement is carried out in accordance with JIS K 7136:2000. The haze measured in this manner is referred to as a haze (Ha). Next, a few drops of only glycerin are added dropwise and sandwiched between two glass plates, and the haze measurement is carried out in the same manner as described above. The haze measured in this manner is referred to as a glass haze (Hb). Then, the inside haze value is calculated by subtracting the value of the glass haze (Hb) from the value of the haze (Ha).

In the present invention and the present specification, the outside haze of the substrate is a value measured in accordance with JIS K 7136:2000. An example of the measuring device is a haze meter NDH2000 (manufactured by Nippon Denshoku Industries Co., Ltd.).

The inside haze of the wavelength conversion member is preferably 30% or more, more preferably 40% or more, and still more preferably 50% or more. On the other hand, from the viewpoint of suppressing a decrease in light transmittance, the inside haze of the wavelength conversion member is preferably 98% or less.

On the other hand, regarding the outside haze of the substrate, in a case where the outside haze of the substrate is high, the light scattering component in the direction outside the wavelength conversion layer is large, so internal scattering within the wavelength conversion layer is reduced, resulting in inefficient absorption of the excitation light by the wavelength conversion material, which tends to reduce brightness and/or color purity. From this point, the outside haze of the substrate is preferably 50% or less and more preferably 40% or less. The outside haze of the substrate can be, for example, 0.5% or more.

From the above-mentioned viewpoint, in one embodiment, in the wavelength conversion member, it is preferable that the outside haze of the substrate is 0.5% or more and 50% or less, and the inside haze of the wavelength conversion member is 30% or more.

In addition, from the above-mentioned viewpoint, in the wavelength conversion member, the inside haze of the wavelength conversion layer and the outside haze of the substrate preferably satisfy a relationship of “inside haze≥0.5×outside haze”, more preferably a relationship of “inside haze≥0.75×outside haze”, and still more preferably a relationship of “inside haze≥outside haze”.

<Pyrromethene Derivative>

The pyrromethene derivative is preferably a compound represented by General Formula (1).

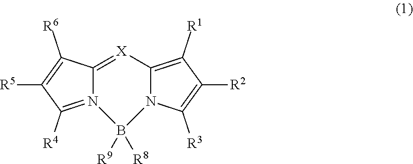

(In General Formula (1), X is C—R⁷ or N (nitrogen atom). R¹ to R⁹ may be the same as or different from each other, and are each independently selected from a hydrogen atom, an alkyl group, a cycloalkyl group, a heterocyclic group, an alkenyl group, a cycloalkenyl group, an alkynyl group, a hydroxy group, a thiol group, an alkoxy group, an alkylthio group, an aryl ether group, an aryl thioether group, an aryl group, a heteroaryl group, a halogen, a cyano group, an aldehyde group, a carbonyl group, a carboxyl group, an ester group, a carbamoyl group, an amino group, a nitro group, a silyl group, a siloxanyl group, a boryl group, a sulfo group, a phosphine oxide group, and a fused ring and an aliphatic ring formed between adjacent substituents.)

It is preferable that X in General Formula (1) is C—R⁷ where R⁷ is a group represented by General Formula (2).

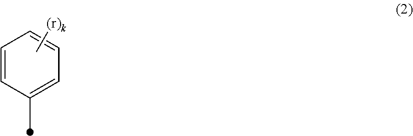

(In General Formula (2), r is selected from the group consisting of a hydrogen atom, an alkyl group, a cycloalkyl group, a heterocyclic group, an alkenyl group, a cycloalkenyl group, an alkynyl group, a hydroxy group, a thiol group, an alkoxy group, an alkylthio group, an aryl ether group, an aryl thioether group, an aryl group, a heteroaryl group, a halogen, a cyano group, an aldehyde group, a carbonyl group, a carboxyl group, an ester group, a carbamoyl group, an amino group, a nitro group, a silyl group, a siloxanyl group, a boryl group, a sulfo group, and a phosphine oxide group. k is an integer in a range of 1 to 3. In a case where k is 2 or more, r's may be the same as or different from each other.)

In General Formula (1), at least one of R¹, R², . . . , or R⁶ is preferably an electron-withdrawing group. Preferred examples of the electron-withdrawing group include a fluorine atom, a fluorine-containing aryl group, a fluorine-containing heteroaryl group, a fluorine-containing alkyl group, a substituted or unsubstituted acyl group, a substituted or unsubstituted ester group, a substituted or unsubstituted amide group, and a substituted or unsubstituted sulfonyl group or cyano group.

In General Formula (1), either one of R⁸ or R⁹ is preferably a cyano group.

In addition to the above compound, pyrromethene derivatives described in WO2019/146332A, WO2016/190238A, WO2018/101129A, WO2017/002707A, and WO2020/045242A are preferably used.

Examples of the compound represented by General Formula (1) are shown below. However, the compound represented by General Formula (1) is not limited thereto.

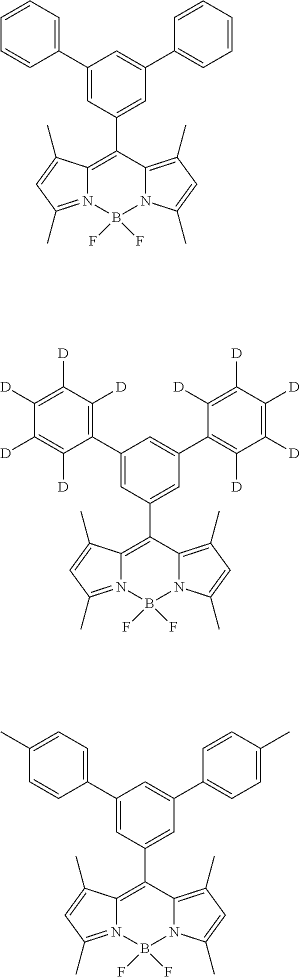

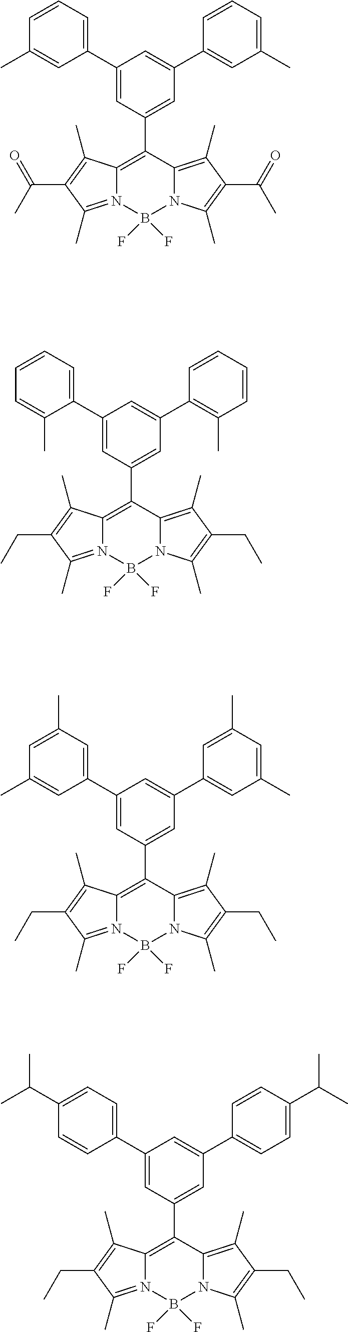

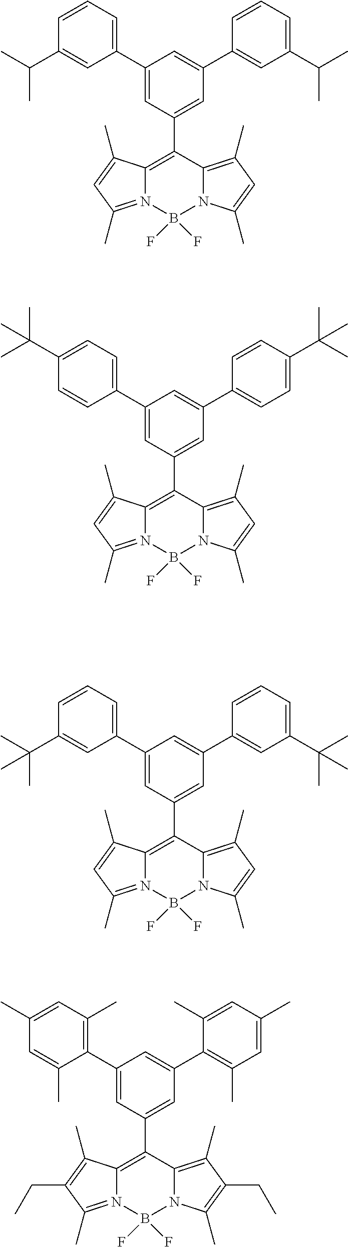

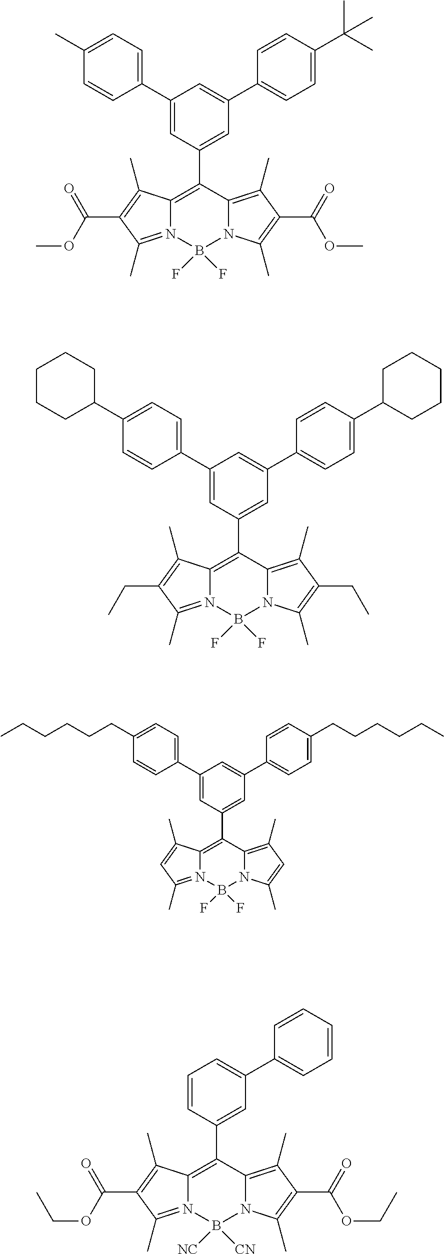

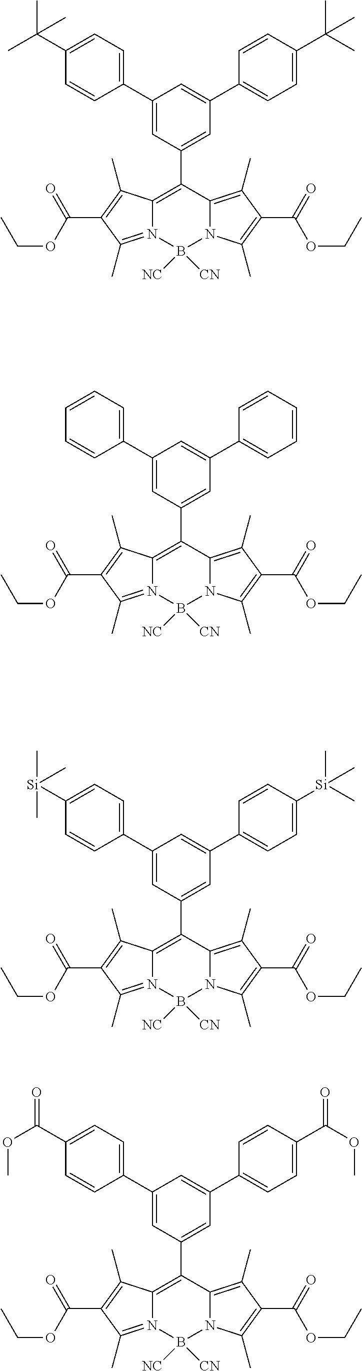

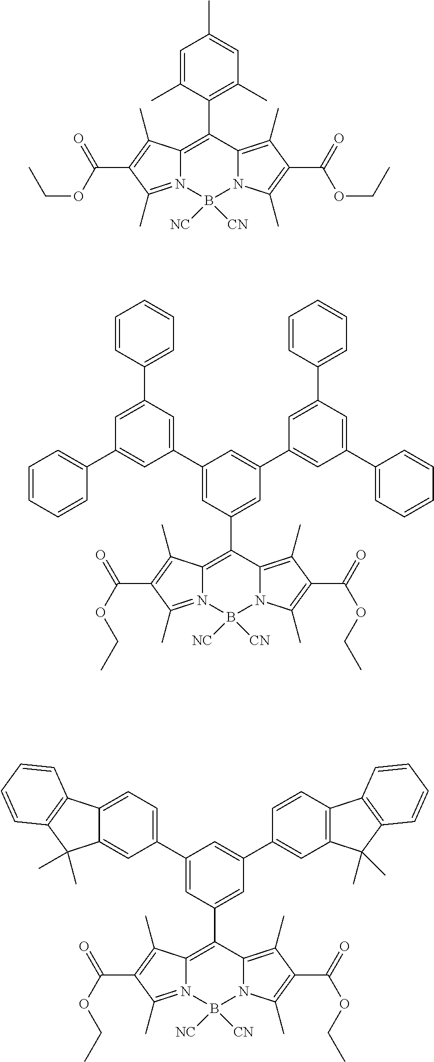

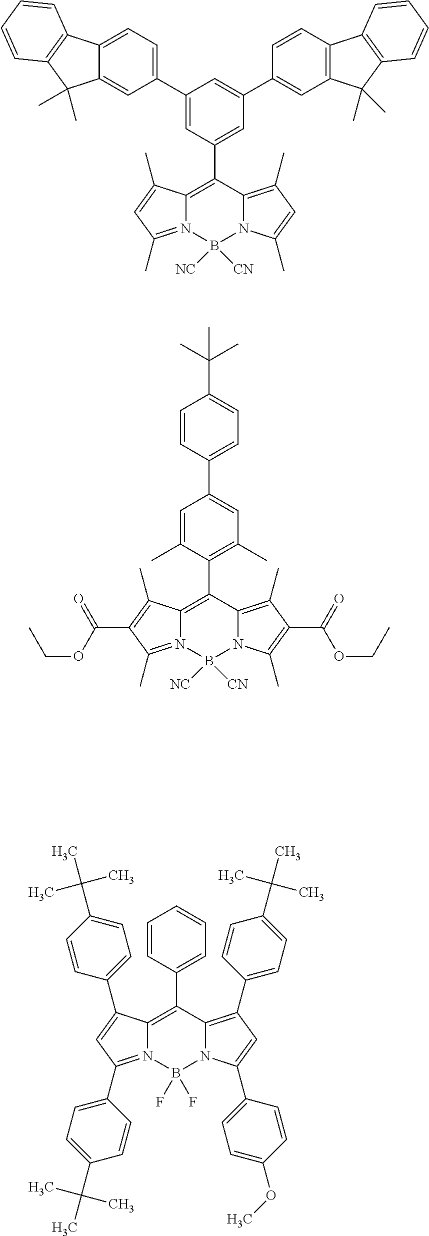

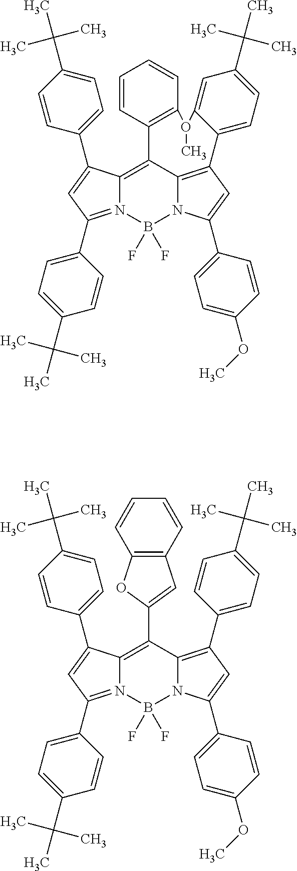

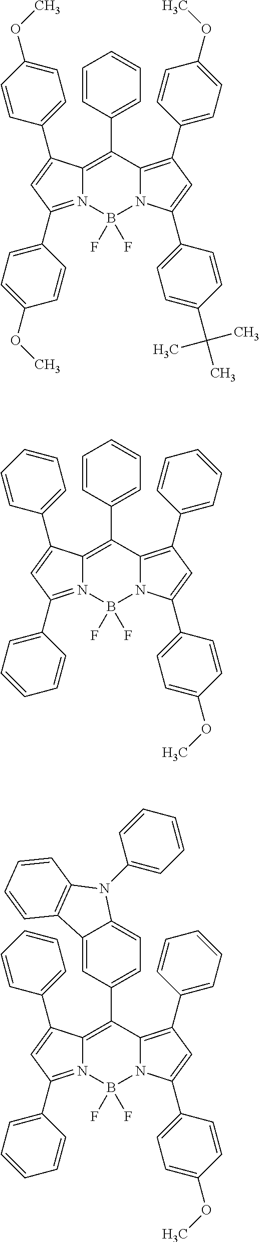

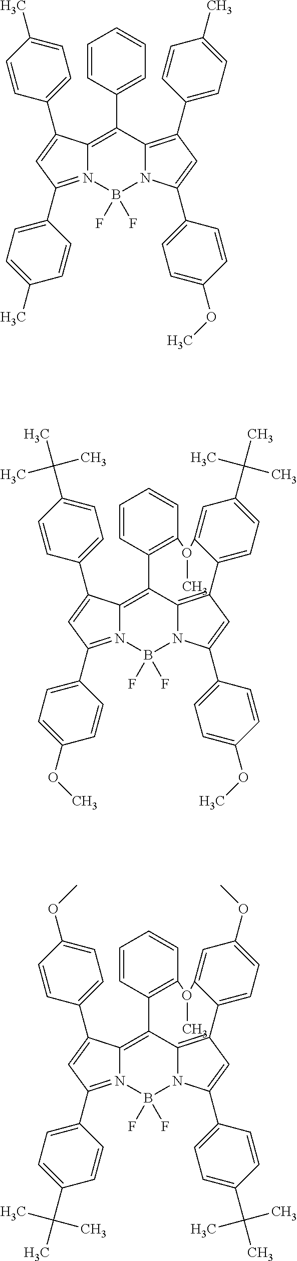

The compound represented by General Formula (1) can be synthesized with reference to the methods described in JP1996-509471A (JP-H08-509471A), JP2000-208262A, [J. Org. Chem., vol. 64, No. 21, pp. 7813 to 7819 (1999)], [Angew. Chem., Int. Ed. Engl., vol. 36, pp. 1333 to 1335 (1997)], and the like.

The wavelength conversion layer can appropriately contain other compounds, if necessary, in addition to the compound represented by General Formula (1). For example, an assist dopant such as rubrene may be contained in order to further increase the efficiency of energy transfer from excitation light to the compound represented by General Formula (1). In addition, in a case where it is desired to add a luminescence wavelength other than the luminescence wavelength of the compound represented by General Formula (1), a desired organic light emitting material, for example, a compound such as a coumarin-based light emitting material, a perylene-based light emitting material, a phthalocyanine-based light emitting material, a stilbene-based light emitting material, a cyanine-based light emitting material, a polyphenylene-based light emitting material, a rhodamine-based light emitting material, a pyridine-based light emitting material, a pyrromethene-based light emitting material, a porphyrin-based light emitting material, an oxazine-based light emitting material, or a pyrazine-based light emitting material can be added. In addition to these organic light emitting materials, it is also possible to add a combination of known light emitting materials such as an inorganic phosphor, a fluorescent pigment, a fluorescent dye, and a quantum dot.

In one embodiment, the pyrromethene derivative of the first example contained in the wavelength conversion layer is preferably a pyrromethene derivative exhibiting light emission by using excitation light, in which a peak wavelength is observed in a region of 500 nm or more and 580 nm or less. That is, the wavelength conversion layer preferably has a wavelength conversion layer containing the following light emitting material (a). The light emitting material (a) is a light emitting material exhibiting light emission by using excitation light in a wavelength range of 400 nm or more and 500 nm or less, in which a peak wavelength is observed in a region of 500 nm or more and 580 nm or less. Hereinafter, the light emission in which a peak wavelength is observed in a region of 500 nm or more and 580 nm or less is referred to as “green wavelength light emission”.

In addition, in one embodiment, the pyrromethene derivative of the second example contained in the wavelength conversion layer is preferably a pyrromethene derivative exhibiting light emission by using excitation light, in which a peak wavelength is observed in a region of 580 nm or more and 750 nm or less. That is, the wavelength conversion layer preferably has a wavelength conversion layer containing the following light emitting material (b). The light emitting material (b) is a light emitting material exhibiting light emission in which a peak wavelength is observed in a region of 580 nm or more and 750 nm or less by being excited by at least one of excitation light in a wavelength range of 400 nm or more and 500 nm or less or light emission from the light emitting material (a). Hereinafter, the light emission in which a peak wavelength is observed in a region of 580 nm or more and 750 nm or less is referred to as “red wavelength light emission”. Hereinafter, the light emitting material exhibiting light emission by using excitation light, in which a peak wavelength is observed in a region of 500 nm or more and 580 nm or less, is also referred to as a “green light emitting body”, and the light emitting material exhibiting light emission by using excitation light, in which a peak wavelength is observed in a region of 580 nm or more and 750 nm or less, is also referred to as a “red light emitting body”.

In addition, in one embodiment, it is preferable that the wavelength conversion member contains the light emitting material (a) and the light emitting material (b). That is, it is preferable that the wavelength conversion member includes a wavelength conversion layer containing the light emitting material (a) (green wavelength conversion layer) and a wavelength conversion layer containing the light emitting material (b) (red wavelength conversion layer). In addition to this point, it is preferable that at least one of the light emitting material (a) or the light emitting material (b) is the pyrromethene derivative. It should be noted that only one type of the light emitting material (a) may be used alone, or a plurality of types of the light emitting materials (a) may be used in combination. Similarly, only one type of the light emitting material (b) may be used alone, or a plurality of types of the light emitting materials (b) may be used in combination.

In a case where both the light emitting material (a) exhibiting green light emission and the light emitting material (b) exhibiting red light emission are contained, a part of the green light emission is converted into red light emission, so a content wa of the light emitting material (a) and a content wb of the light emitting material (b) preferably have a relationship of wa≥wb, and the content ratio of each material is wa:wb=preferably 1000:1 to 1:1, more preferably 500:1 to 2:1, and still more preferably 200:1 to 3:1. wa and wb are mass percent with respect to the mass of the wavelength conversion layer.

A part of the excitation light in a wavelength range of 400 nm or more and 500 nm or less usually transmits through a portion of the wavelength conversion member other than the wavelength conversion layer (for example, a concave portion where the wavelength conversion layer is not formed) without transmitting through the wavelength conversion layer. Therefore, the transmitted partial excitation light itself can be used as blue wavelength light emission. Therefore, in a case where the wavelength conversion member contains the light emitting material (a) exhibiting green wavelength light emission and the light emitting material (b) exhibiting red wavelength light emission in each wavelength conversion layer, and a blue wavelength light source that emits blue wavelength light with a sharp emission peak (for example, a blue wavelength organic EL element or a blue wavelength LED) is used as a light source, a sharp emission spectrum is exhibited at each of blue, green, and red wavelengths, which makes it possible to obtain white wavelength light having good wavelength purity.

<Binder>

Examples of the resin that forms the binder contained in the wavelength conversion layer include an acrylic resin, an epoxy resin, a polyimide resin, a urethane resin, a urea resin, a polyvinyl alcohol resin, a melamine resin, a polyamide resin, a polyamideimide resin, a polyester resin, a polyolefin resin, a silicone resin, a polycarbonate resin, a cycloolefin resin, a phenoxy resin, and a polymer dispersant. The binder resin may include two or more thereof, or may be a copolymer thereof. For example, a copolymer of methyl methacrylate and an aliphatic polyolefin resin can be mentioned. Among these resin materials, an acrylic resin is preferable from the viewpoint of stability.

Examples of the acrylic resin include a polymer of an unsaturated carboxylic acid, and a copolymer of an unsaturated carboxylic acid and another ethylenically unsaturated compound. Among these resin compounds, a copolymer of an unsaturated carboxylic acid and an ethylenically unsaturated compound is preferable.

Examples of the unsaturated carboxylic acid include acrylic acid, methacrylic acid, itaconic acid, crotonic acid, maleic acid, fumaric acid, and vinyl acetic acid. Two or more thereof may be used as the unsaturated carboxylic acid.

Examples of the ethylenically unsaturated compound include an unsaturated carboxylic acid alkyl ester, an aliphatic vinyl compound, an aromatic vinyl compound, an unsaturated carboxylic acid aminoalkyl ester, an unsaturated carboxylic acid glycidyl ester, a carboxylic acid vinyl ester, a vinyl cyanide compound, an aliphatic conjugated diene, and a macromonomer. Examples of the unsaturated carboxylic acid alkyl ester include methyl acrylate, methyl methacrylate, ethyl acrylate, ethyl methacrylate, n-propyl acrylate, isopropyl acrylate, isopropyl methacrylate, n-propyl methacrylate, n-butyl acrylate, n-butyl methacrylate, sec-butyl acrylate, sec-butyl methacrylate, iso-butyl acrylate, iso-butyl methacrylate, tert-butyl acrylate, tert-butyl methacrylate, n-pentyl acrylate, n-pentyl methacrylate, 2-hydroxyethyl acrylate, 2-hydroxyethyl methacrylate, benzyl acrylate, and benzyl methacrylate. Examples of the aliphatic vinyl compound include ethylene, n-propylene, n-butene, n-pentene, n-hexene, vinyl cyclobutane, vinyl cyclopentane, and vinyl cyclohexane. “n-”, “sec-”, and “tert-” are abbreviations for “normal-”, “secondary-”, and “tertiary-”, respectively. Examples of the aromatic vinyl compound include styrene, p-methylstyrene, o-methylstyrene, m-methylstyrene, α-methylstyrene, and a fluorene skeleton-containing monomer. “o-”, “m-”, and “p-” are abbreviations for “ortho-”, “meta-”, and “para-”, respectively. Examples of the unsaturated carboxylic acid aminoalkyl ester include aminoethyl acrylate. Examples of the unsaturated carboxylic acid glycidyl ester include glycidyl acrylate and glycidyl methacrylate. Examples of the carboxylic acid vinyl ester include vinyl acetate and vinyl propionate. Examples of the vinyl cyanide compound include acrylonitrile, methacrylonitrile, and α-chloroacrylonitrile. Examples of the aliphatic conjugated diene include 1,3-butadiene and isoprene. Examples of the macromonomer include polystyrene, polymethylacrylate, polymethylmethacrylate, polybutylacrylate, polybutylmethacrylate, and polysilicone, each of which has an acryloyl group or a methacryloyl group at the terminal.

In addition, the acrylic resin preferably has an ethylenically unsaturated group in the side chain. Examples of the ethylenically unsaturated group include a vinyl group, an allyl group, an acrylic group, and a methacrylic group. As for a method of introducing an ethylenically unsaturated group into a side chain of an acrylic resin, in a case where the acrylic resin has a carboxyl group, a hydroxy group, or the like, for example, there is a method of subjecting the acrylic resin to an addition reaction with an ethylenically unsaturated compound having an epoxy group, an acrylic acid chloride, a methacrylic acid chloride, or the like, or a method of adding a compound having an ethylenically unsaturated group to the acrylic resin using isocyanate.

Examples of the acrylic resin having an ethyl enically unsaturated group in the side chain include “CYCLOMER” (registered trademark) P (ACA) Z250 (manufactured by Daicel-Allnex Ltd., 45% by weight solution of dipropylene glycol monomethyl ether, acid value: 110 mgKOH/g, weight-average molecular weight: 20,000).

In addition, examples of the reactive monomer capable of forming the resin include oligomers such as bisphenol A diglycidyl ether (meth)acrylate, poly(meth)acrylate carbamate, modified bisphenol A epoxy (meth)acrylate, adipic acid 1,6-hexanediol (meth)acrylic acid ester, phthalic anhydride propylene oxide (meth)acrylic acid ester, trimellitic acid diethylene glycol (meth)acrylic acid ester, rosin-modified epoxy di(meth)acrylate, and alkyd-modified (meth)acrylate, tripropylene glycol di(meth)acrylate, 1,6-hexanediol di(meth)acrylate, bisphenol A diglycidyl ether di(meth)acrylate, trimethylolpropane tri(meth)acrylate, tetratrimethylolpropane tri(meth)acrylate, pentaerythritol tri(meth)acrylate, triacrylic formal, pentaerythritol tetra(meth)acrylate, dipentaerythritol hexa(meth)acrylate, dipentaerythritol penta(meth)acrylate, bi sphenoxyethanol fluorene diacrylate, dicyclopentanedienyl diacrylate, alkyl-modified products thereof, alkyl ether-modified products thereof, and alkyl ester-modified products thereof. The reactive monomer may include two or more thereof

From the viewpoint of being able to improve the compatibility with the light emitting material and improve the durability, the glass transition temperature (Tg) of the resin is preferably 50° C. or higher, more preferably 70° C. or higher, still more preferably 80° C. or higher, and even still more preferably 90° C. or higher. In addition, from the viewpoint of being able to obtain an appropriate film hardness and suppress the occurrence of cracks and the like during film formation, Tg is preferably 200° C. or lower, more preferably 180° C. or lower, still more preferably 170° C. or lower, and even still more preferably 160° C. or lower. In a case where Tg of the resin is within the above range, higher durability can be obtained in the wavelength conversion member.

The glass transition temperature can be measured with a commercially available measuring device (for example, a differential scanning calorimeter (DSC7000X) manufactured by Hitachi High-Tech Science Corporation, heating rate: 10° C./min).

There is a strong relationship between the SP value, which is a solubility parameter of the binder resin, and the emission peak wavelength of the organic light emitting material. In the binder resin having a large SP value, the excited state of the organic light emitting material is stabilized by the interaction between the binder resin and the organic light emitting material. Therefore, the emission peak wavelength of this organic light emitting material shifts to a long wavelength side as compared with the case of the binder resin having a small SP value. Therefore, it is possible to optimize the emission peak wavelength of the organic light emitting material by dispersing the organic light emitting material in a binder resin having an optimum SP value. By optimizing the emission peak wavelength of light emission of an organic light emitting material having high color purity, it is possible to reduce the density of a color filter and increase the brightness of a display, for example, in a case where the organic light emitting material is incorporated into a light source of the display as described later.

In a case where the SP value of the resin is SP≤12.0 (cal/cm³)^{0.5}, the emission peak wavelength of red light is suppressed from becoming longer, and as a result, the difference between the emission peak wavelengths of green light and red light is reduced, which is therefore preferable. From the viewpoint of further increasing the effect, the SP value of the resin is more preferably SP≤11.0 (cal/cm³)^{0.5} and still more preferably SP≤10.8 (cal/cm³)^{0.5}. In addition, a binder resin having a lower limit value of SP≥7.0 (cal/cm³)^{0.5} has good dispersibility of the organic light emitting material, and thus can be suitably used. From the viewpoint of further increasing the effect, the SP value of the resin is more preferably SP≥8.0 (cal/cm³)^{0.5}, still more preferably SP≥8.5 (cal/cm³)^{0.5}, even still more preferably SP≥9.0 (cal/cm³)^{0.5}, and even still further preferably SP≥9.5 (cal/cm³)^{0.5}.

Here, the solubility parameter (SP value) is a value calculated from the types and ratios of monomers constituting the resin using the Fedors estimation method described in [Poly. Eng. Sci., vol. 14, No. 2, pp. 147 to 154 (1974)] or the like, which is commonly used. The SP value for a mixture of a plurality of types of resins can also be calculated by the same method. For example, the SP value of polymethyl methacrylate can be calculated as 9.7 (cal/cm³)^{0.5}, the SP value of polyethylene terephthalate (PET) can be calculated as 10.8 (cal/cm³)^{0.5}, and the SP value of a bisphenol A-based epoxy resin can be calculated as 10.9 (cal/cm³)^{0.5}.

In addition, the weight-average molecular weight (Mw) of the resin is preferably 5,000 or more, more preferably 15,000 or more, and still more preferably 20,000 or more and is preferably 500,000 or less, more preferably 100,000 or less, and still more preferably 50,000 or less. In a case where the weight-average molecular weight is within the above range, a wavelength conversion member having good compatibility with a light emitting material and having higher durability can be obtained.

The weight-average molecular weight in the present invention and the present specification is a value measured by gel permeation chromatography (GPC). Specifically, the weight-average molecular weight is a value in terms of polystyrene obtained by filtering a sample through a membrane filter having a pore diameter of 0.45 μm and then carrying out GPC (HLC-82A manufactured by Tosoh Corporation) (development solvent: toluene, development rate: 1.0 mL/min, column: TSKgel G2000HXL manufactured by Tosoh Corporation).

The method for synthesizing the resin is not particularly limited, and a known method can be appropriately used. A commercially available product can also be used as the resin.

Specific examples of the commercially available product include “OKP4” and “OKP-A1” (manufactured by Osaka Gas Chemicals Co., Ltd.), “DIANAL BR-83, BR-85, and BR-87” (manufactured by Mitsubishi Chemical Corporation), “VYLON 200, GK-360, UR-1400, and UR-4800” (manufactured by Toyobo Co., Ltd.), “OLYCOX KC-700 and KC-7000F” (manufactured by Kyoeisha Chemical Co., Ltd.), “NICHIGO POLYESTER TP-220, TP-294, and LP-033” (manufactured by The Nippon Synthetic Chemical Industry Co., Ltd.), “IUPIZETA EP-5000, OPTIMAS 7500, and OPTIMAS 6000” (manufactured by Mitsubishi Gas Chemical Company, Inc.), “ARON PE-1000, A-104, A-106, S-1001, S-1017, and 52060” (manufactured by Toagosei Co., Ltd.), and “HI-PEARL M-4006 and M-4620” (manufactured by Negami Chemical Industrial Co., Ltd.).

In addition, examples of a photopolymerization initiator that can be used for forming the binder resin include a benzophenone-based compound, an acetophenone-based compound, an anthraquinone-based compound, an imidazole-based compound, a benzothiazole-based compound, a benzoxazole-based compound, an oxime ester compound, a triazine-based compound, a phosphorus-based compound, and an inorganic photopolymerization initiator such as titanate. The photopolymerization initiator may include two or more thereof. A nitrocarbazole-based oxime ester compound is preferable in order to easily adjust the content of the photopolymerization initiator to a preferred range which will be described later.

More specifically, examples of the benzophenone-based compound include benzophenone, N,N′-tetraethyl-4,4′-diaminobenzophenone, and 4-methoxy-4′-dimethylaminobenzophenone. Examples of the acetophenone-based compound include 2,2-diethoxyacetophenone, benzoin, benzoin methyl ether, benzoin isobutyl ether, benzyl dimethyl ketal, α-hydroxyisobutylphenone, 1-hydroxycyclohexylphenylketone, 2-methyl-1-[4-(methylthio)phenyl]-2-morpholino-1-propane, “IRGACURE” (registered trademark) 369 (2-benzyl-2-dimethylamino-1-(4-morpholinophenyl)-butanone), and IRGACURE 379 (2-(dimethylamino)-2-[(4-methylphenyl)methyl]-1-[4-(4-morpholinyl)phenyl]-1-butanone). Examples of the anthraquinone-based compound include t-butyl anthraquinone, 1-chloroanthraquinone, 2,3-dichloroanthraquinone, 3-chloro-2-methylanthraquinone, 2-ethylanthraquinone, 1,4-naphthoquinone, 9,10-phenantraquinone, 1,2-benzoanthraquinone, 1,4-dimethylanthraquinone, and 2-phenylanthraquinone. Examples of the imidazole-based compound include 2-(o-chlorophenyl)-4,5-diphenylimidazole dimer. Examples of the benzothiazole-based compound include 2-mercaptobenzothiazole. Examples of the benzoxazole-based compound include 2-mercaptobenzoxazole. Examples of the triazine-based compound include 4-(p-methoxyphenyl)-2,6-di-(trichloromethyl)-s-triazine. Examples of the oxime ester compound include 1,2-octanedione, 1[4-(phenylthio)-2-(O-benzoyloxime)] (“IRGACURE” (registered trademark) OXE01, manufactured by BASF SE), ethanone, 1-[9-ethyl-6-(2-methylbenzoyl)-9H-carbazol-3-yl]-1-(O-acetyloxime) (“IRGACURE” OXE03), “IRGACURE” OXE04, “ADEKA ARKLS” (registered trademark) NCI-930, “ADEKA ARKLS” NCI-831, “ADEKA ARKLS” N-1919, and PBG-345 (manufactured by Changzhou Tronly New Electronic Materials Co., Ltd.). Among these compounds, an oxime ester compound is preferable from the viewpoint of high sensitivity, and a nitrocarbazole-based oxime ester compound is more preferable from the viewpoint of suppressing a decrease in brightness in a case where oxygen is blocked. “ADEKA ARKLS” NCI-831, PBG-345 (manufactured by Changzhou Tronly New Electronic Materials Co., Ltd.), and the like are preferable as the nitrocarbazole-based oxime ester compound.

In one embodiment, from the viewpoint of suppressing surface roughness, the content of the photopolymerization initiator is preferably 1% by mass or more in the solid content of the composition for forming a wavelength conversion layer, and from the viewpoint of compatibility, the content of the photopolymerization initiator is preferably 10% by mass or less in the solid content of the composition for forming a wavelength conversion layer. In addition, the composition for forming a wavelength conversion layer may contain a chain transfer agent together with the photopolymerization initiator.

In addition, examples of the organic solvent contained in the composition for forming a wavelength conversion layer include diethylene glycol monobutyl ether acetate, benzyl acetate, ethyl benzoate, methyl benzoate, diethyl malonate, 2-ethylhexyl acetate, 2-butoxyethyl acetate, ethylene glycol monobutyl ether acetate, diethyl oxalate, ethyl acetoacetate, cyclohexyl acetate, 3-methoxy-butyl acetate, methyl acetoacetate, ethyl-3-ethoxy propionate, 2-ethylbutyl acetate, isopentyl propionate, propylene glycol monomethyl ether propionate, pentyl acetate, propylene glycol monomethyl ether acetate, ethylene glycol monomethyl ether, ethylene glycol monoethyl ether, propylene glycol monoethyl ether, diethylene glycol monomethyl ether, monoethyl ether, methyl carbitol, ethyl carbitol, propylene glycol monomethyl ether, propylene glycol monoethyl ether, propylene glycol tertiary butyl ether, dipropylene glycol monomethyl ether, ethyl acetate, butyl acetate, isopentylbutanol acetate, 3-methyl-2-butanol, 3-methyl-3-methoxybutanol, cyclopentanone, cyclohexanone, xylene, ethylbenzene, and solvent naphtha. The organic solvent may be a mixed solvent containing two or more thereof. From the viewpoint of improving the coatability, the content of the organic solvent in the composition for forming a wavelength conversion layer is preferably 40% by mass or more and more preferably 50% by mass or more in the composition for forming a wavelength conversion layer. On the other hand, from the viewpoint of improving the drying characteristics, the content of the organic solvent is preferably 95% by mass or less and more preferably 90% by mass or less in the composition for forming a wavelength conversion layer.

In addition, in a case where the composition for forming a wavelength conversion layer contains an adhesion improver, the adhesiveness of the wavelength conversion layer to the substrate can be improved. Examples of the adhesion improver include silane coupling agents such as vinyltrimethoxysilane, vinyltriethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyl dimethoxysilane, 3-chloropropyltrimethoxysilane, 3-methacryloxypropyltrimethoxysilane, and 3-mercaptopropyltrimethoxysilane. The adhesion improver may include two or more thereof.

In addition, in a case where the composition for forming a wavelength conversion layer contains a surfactant, the coatability and the uniformity of the coating film surface can be improved. Examples of the surfactant include an anionic surfactant, a cationic surfactant, an amphoteric surfactant, a non-ionic surfactant, a fluorine-based surfactant, and a silicone-based surfactant. Examples of the anionic surfactant include ammonium lauryl sulfate and triethanolamine polyoxyethylene alkyl ether sulfate. Examples of the cationic surfactant include stearyl amine acetate and lauryl trimethylammonium chloride. Examples of the amphoteric surfactant include lauryl dimethylamine oxide and lauryl carboxymethyl hydroxyethyl imidazolium betaine. Examples of the non-ionic surfactant include polyoxyethylene lauryl ether, polyoxyethylene stearyl ether, and sorbitan monostearate. The surfactant may include two or more thereof. From the viewpoint of in-plane uniformity of the coating film, the content of the surfactant is preferably 0.001% by mass or more and 10% by mass or less in the composition for forming a wavelength conversion layer.

In addition, examples of the dispersant contained in the composition for forming a wavelength conversion layer include low-molecular-weight dispersants such as intermediates and derivatives of pigments, and polymer dispersants. Examples of the pigment derivative contained in the composition for forming a wavelength conversion layer include an alkylamine-modified product having a pigment skeleton, a carboxylic acid derivative having a pigment skeleton, and a sulfonic acid derivative having a pigment skeleton, which contribute to appropriate wetting and/or stabilization of pigments. Among these pigment derivatives, a sulfonic acid derivative having a pigment skeleton, which has a significant effect on the stabilization of fine pigments, is preferable.

In addition, examples of the polymer dispersant contained in the composition for forming a wavelength conversion layer include polymers such as polyester, polyalkylamine, polyallylamine, polyimine, polyamide, polyurethane, polyacrylate, polyimide, and polyamideimide, and copolymers thereof. The polymer dispersant may include two or more thereof. Among these polymer dispersants, a polymer dispersant having an amine value in terms of solid contents of 5 to 200 mgKOH/g and an acid value in terms of solid contents of 1 to 100 mgKOH/g is preferable. In particular, a polymer dispersant having a basic group is more preferable, and the inclusion of the polymer dispersant makes it possible to improve the storage stability of the composition for forming a wavelength conversion layer. Examples of commercially available polymer dispersants having a basic group include “SOLSPERSE” (registered trademark) 24000 (manufactured by Avecia, Inc.), “EFKA” (registered trademark) 4300, 4330, and 4340 (manufactured by EFKA Co., Ltd.), “AJISPER” (registered trademark) PB821 and PB822 (manufactured by Ajinomoto Fine-Techno Co., Inc.), and “BYK” (registered trademark) 161 to 163, 2000, 2001, 6919, and 21116 (manufactured by BYK-Chemie GmbH).

In addition, in a case where the composition for forming a wavelength conversion layer contains a polymerization inhibitor, the stability can be improved. The polymerization inhibitor generally exhibits an effect of inhibiting or terminating polymerization by radicals generated by heat, light, a radical initiator, or the like, and is used for preventing gelation of thermosetting resins and/or terminating polymerization during polymer production. Examples of the polymerization inhibitor include hydroquinone, tert-butylhydroquinone, 2,5-bis(1,1,3,3-tetramethylbutyl)hydroquinone, 2,5-bis(1,1-dimethylbutyl)hydroquinone, catechol, and tert-butylcatechol. The polymerization inhibitor may include two or more thereof.

<Other Additives>

In addition to the pyrromethene derivative, the binder, and the light scattering particles, the wavelength conversion member may contain other additives, for example, an antioxidant, a processing and heat stabilizer, a light resistance stabilizer such as an ultraviolet absorbent, a dispersant for stabilizing a coating film, a leveling agent, a plasticizer, a crosslinking agent such as an epoxy compound, a curing agent such as an amine, an acid anhydride, or imidazole, an adhesion aid such as a silane coupling agent as a modifier for the surface of members, silica particles as a sedimentation inhibitor for a pyrromethene derivative or the like, inorganic particles such as silicone fine particles, and a silane coupling agent.

Examples of the antioxidant include phenolic antioxidants such as 2,6-di-tert-butyl-p-cresol and 2,6-di-tert-butyl-4-ethylphenol. However, the antioxidant is not limited thereto. In addition, these antioxidants may be used alone or in combination of a plurality thereof.

Examples of the processing and heat stabilizer include phosphorus-based stabilizers such as tributylphosphite, tricyclohexylphosphite, triethylphosphine, and diphenylbutylphosphine. However, the processing and heat stabilizer is not limited thereto. In addition, these stabilizers may be used alone or in combination of a plurality thereof

Examples of the light resistance stabilizer include benzotriazoles such as 2-(5-methyl-2-hydroxyphenyl)benzotriazole and 2-[2-hydroxy-3,5-bis(α,α-dimethylbenzyl)phenyl]-2H-benzotriazole. However, the light resistance stabilizer is not limited thereto. In addition, these light resistance stabilizers may be used alone or in combination of a plurality thereof.

From the viewpoint of not inhibiting the light from the light source and/or the light emission of the light emitting material, these additives preferably have a small light absorption coefficient in a visible range. Specifically, these additives preferably have a molar absorption coefficient c of 1,000 or less and more preferably 500 or less over the entire wavelength range of 400 nm or more and 800 nm or less. The molar absorption coefficient c is still more preferably 200 or less and particularly preferably 100 or less.

In addition, a compound having a role as a singlet oxygen quencher can also be suitably used as the light resistance stabilizer. The singlet oxygen quencher is a material that traps and inactivates singlet oxygen, which is generated in a case where oxygen molecules are activated by the energy of light. The coexistence of the singlet oxygen quencher in the wavelength conversion member makes it possible to prevent the light emitting material from being deteriorated by singlet oxygen.

It is known that singlet oxygen is generated by the exchange of electrons and energy between a triplet excited state of a coloring agent such as Rose bengal or methylene blue and an oxygen molecule in a ground state.

The wavelength conversion member can carry out color conversion (that is, wavelength conversion) of light by exciting the pyrromethene derivative contained in the wavelength conversion layer with excitation light and emitting light having a wavelength different from that of the excitation light. Since this excitation-light emission cycle is repeated, the interaction between the generated excited species and oxygen contained in the wavelength conversion member increases the probability of generating singlet oxygen. As a result, the probability of collision between the pyrromethene derivative and the singlet oxygen also increases, so that the deterioration of the pyrromethene derivative is likely to proceed.

The pyrromethene derivative is an organic light emitting material. The organic light emitting material is more susceptible to singlet oxygen than the inorganic light emitting material. In particular, the compound represented by General Formula (1) has higher reactivity with singlet oxygen than a compound having a fused aryl ring such as perylene and a derivative thereof, and exhibits a large effect of singlet oxygen on the durability thereof. Therefore, the durability of the compound represented by General Formula (1), which is excellent in emission quantum yield and color purity, can be improved by rapidly inactivating the generated singlet oxygen with the singlet oxygen quencher.

Examples of the compound having a role as the singlet oxygen quencher include a tertiary amine, a catechol derivative, and a nickel compound. However, the compound having a role as the singlet oxygen quencher is not limited thereto. In addition, these compounds (light resistance stabilizers) may be used alone or in combination of a plurality thereof

<Substrate>

Various film-like materials (sheet-like materials) used for known wavelength conversion members can be used as a substrate 22. In the present invention and the present specification, the film and the sheet are synonymous with each other. Various film-like materials that can support a wavelength conversion layer 21 and a coating liquid to be formed into the wavelength conversion layer 21 can be used as the substrate 22. The substrate 22 is preferably transparent, and for example, glass, a transparent inorganic crystalline material, or a transparent resin material can be used. In addition, the substrate 22 may be rigid or flexible. Further, the substrate 22 may have an elongated shape that can be wound or a single sheet shape that has been cut into predetermined dimensions in advance.

From the viewpoint of ease of thinning, ease of weight reduction, and suitability for flexibility, films consisting of various resin materials (polymer materials) are suitably used as the substrate 22.

Specifically, resin films consisting of polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), ABS, cycloolefin copolymer (COC), cycloolefin polymer (COP), and triacetyl cellulose (TAC) are suitably exemplified.

In addition, gas barrier films in which a gas barrier layer exhibiting gas barrier properties is formed on these resin films can also be used as the substrate 22.

Here, the substrate 22 preferably has an oxygen permeability of 0.1 to 100 cc/(m²·day·atm) and more preferably 1 to 50 cc/(m²·day·atm). The SI unit of the oxygen permeability is [fm/(s·Pa)]. [cc/(m²·day·atm)] can be converted into the SI unit by means of “1 fm/(s·Pa)=8.752 cc/(m²·day·atm)”.

It is preferable that the oxygen permeability of the substrate 22 is 100 cc/(m²·day·atm) or less from the viewpoint that it is possible to suitably prevent deterioration of the pyrromethene derivative due to oxygen, and it is possible to prevent deterioration of the binder.

In addition, a film having a low oxygen permeability, that is, a film having high gas barrier properties is a dense and high-density film or a film having a dense and high-density layer, and may be, for example, a film in which a layer generally consisting of a metal oxide or a metal nitride and having a thickness of several tens to several hundred nm is formed on a film serving as a support. However, such a film having an inorganic substance may degrade the optical properties of the wavelength conversion member 16 due to light absorption of an inorganic layer or the like. In addition, methods such as chemical vapor deposition (CVD) and physical vapor deposition (PVD) are commonly used to form the inorganic layer. However, the film having an inorganic substance as described above is generally expensive due to the low production rate and the extremely high level of quality control of foreign matter and the like. On the other hand, setting the oxygen permeability of the substrate 22 to 0.1 cc/(m²·day·atm) or more is preferable from the viewpoint that a film or the like prepared by a wet process such as a solution coating method or a spray coating method can be selected; it is not necessary to have a dense inorganic layer, so deterioration of the optical properties of the wavelength conversion member 16 due to the substrate 22 can be prevented; and the cost of the wavelength conversion member 16 can be reduced.

In addition, if necessary, the substrate 22 can include one or more layers such as a hard coat layer, an anti-Newton ring layer, an antireflection layer, a low-reflection layer, and an antiglare layer, or together with (or in place of) one or more of these layers, one or more surface layers such as a light scattering layer, a primer layer, an antistatic layer, and an undercoat layer.

(Anti-Newton Ring Layer)

In one embodiment, the wavelength conversion member preferably has an anti-Newton ring layer on the surface of the substrate 22. It is considered that having a specific surface roughness on the surface of the substrate makes it possible to reduce a contact area with other opposing members in a case of being made into a backlight unit, and to suppress the occurrence of scratches on the surface of the wavelength conversion member. In addition, in a case where the wavelength conversion member is disposed to face an optical film, it is preferable that the wavelength conversion member and the optical film are not in optical close contact. From the viewpoint of suppressing optical close contact, the surface of the wavelength conversion member on the side facing the optical film preferably has a surface roughness, and may satisfy a specific surface roughness. In addition, the anti-Newton ring layer may also serve as a light scattering layer.

There is no particular limitation on the method of preparing the wavelength conversion member to have a specific surface roughness. For example, the wavelength conversion member can be prepared to have a specific surface roughness by adjusting the particle diameter and the content of a filler which may be contained in the wavelength conversion layer or the coating material, and the application amount of the resin. The material of the filler is not particularly limited and the filler may be an inorganic filler or an organic filler. From the viewpoint of rub resistance, the filler is preferably an organic filler. The higher the Young's modulus of the filler, the more the occurrence of scratches on the wavelength conversion member is suppressed, while the opposing members may be scratched. From this point of view, the Young's modulus of the filler is preferably 0.1 GPa or more and 30 GPa or less, more preferably 1 GPa or more and 10 GPa or less, and still more preferably 2 GPa or more and 6 GPa or less.

The specific surface roughness is preferably 0.5 μm or more and more preferably 1 μm or more, as an arithmetic average roughness Ra. Regarding the upper limit value of the arithmetic average roughness Ra, the arithmetic average roughness Ra is preferably 20 μm or less from the viewpoint of not impairing the rub resistance.

The arithmetic average roughness Ra refers to a value measured using a three-dimensional (3D) microscope (for example, Model OLS4100 manufactured by Olympus Corporation, magnification of 10 times, white interferometer VertScan (registered trademark) manufactured by Mitsubishi Chemical Systems, Inc., or NewView 7300 manufactured by Zygo Corporation). The analysis range is the line roughness at a length of 1289 μm. In the analysis method, the analysis parameter is a roughness parameter, and the cutoffs are λC: none, λS: none, and λf: none. Here, λC, λS, and λf are methods of calculating a contour curve for calculating Ra. The contour curve includes a profile curve, a roughness curve, and a waviness curve. The profile curve is a curve obtained by applying a low-pass filter having a cutoff value of λS to a measurement profile curve. The roughness curve is a contour curve obtained by blocking long wavelength components from the profile curve with a high-pass filter having a cutoff value of λC. The waviness curve is a contour curve obtained by sequentially applying contour curve filters having cutoff values of λf and λC to the profile curve. Long wavelength components are blocked by the λf contour curve filter, and short wavelength components are blocked by the λC contour curve filter.

The wavelength conversion member 16 shown in FIG. 2 has a configuration in which the wavelength conversion layer 21 is sandwiched between the substrates 22 corresponding to both main surfaces of the wavelength conversion layer 21. However, the present invention is not limited thereto. That is, the wavelength conversion member 16 may have a configuration in which the substrate 22 is provided only on one main surface of the wavelength conversion layer 21. The main surface is a maximum surface of a layer, a film-like material, or the like. The wavelength conversion member 16 preferably has a configuration in which the wavelength conversion layer 21 is sandwiched between the substrates 22, from the viewpoint that the wavelength conversion layer 21 can be suitably protected, the pyrromethene derivative can be prevented from being deteriorated by oxygen, and physical deformation such as curling and bending can be suppressed by increasing the stiffness of the wavelength conversion member 16.

In a case where the wavelength conversion layer 21 is sandwiched between the substrates 22, the two substrates may be the same as or different from each other.

In a case where the wavelength conversion layer 21 is sandwiched between the substrates 22 and then in a case where two substrates are different from each other, it is preferable that at least one of the two substrates 22 satisfies the above-mentioned oxygen permeability and it is more preferable that both of the two substrates 22 satisfy the above-mentioned oxygen permeability.

In addition, the thickness of the substrate 22 is preferably in a range of 5 to 150 μm, more preferably in a range of 10 to 70 μm, and still more preferably in a range of 15 to 55 μm.

Setting the thickness of the substrate 22 to 5 μm or more is preferable from the viewpoint that the wavelength conversion layer 21 can be suitably held and protected, the pyrromethene derivative can be prevented from being deteriorated by oxygen, and physical deformation such as curling and bending can be suppressed by increasing the stiffness of the wavelength conversion member 16.

Setting the thickness of the substrate 22 to 150 μm or less is preferable from the viewpoint that the thickness of the entire wavelength conversion member 16 including the wavelength conversion layer 21 can be reduced.

The method of preparing such a wavelength conversion member 16 is not particularly limited, and various known methods of preparing a laminated film in which a layer exhibiting optical functions is sandwiched between resin films or the like or one surface of the layer exhibiting optical functions is supported by a resin film or the like can be used. The following method is exemplified as a preferred method of preparing the wavelength conversion member 16.

A coating liquid (composition for forming a wavelength conversion layer) is prepared, the coating liquid is applied onto one surface of the substrate 22, and the coating liquid is heated and dried to form the wavelength conversion layer 21. A plurality of layers can also be laminated as the wavelength conversion layer.

The method of applying the coating liquid is not particularly limited, and various known coating methods such as spin coating, die coating, bar coating, and spray coating can be used.

The method of heating and drying the coating liquid is also not particularly limited, and various known methods of drying an aqueous solution, such as heating and drying using a heater, heating and drying using hot air, and heating and drying using a heater and hot air, can be used.

After the wavelength conversion layer 21 is formed, another substrate 22 is further laminated and bonded to the surface of the wavelength conversion layer 21 on which the substrate 22 is not laminated, whereby the wavelength conversion member 16 as shown in FIG. 2 can be prepared. The bonding of the substrate 22 may be carried out by utilizing the adhesion or adhesiveness of the wavelength conversion layer 21, or may be carried out using a transparent pressure sensitive adhesive, a transparent pressure-sensitive adhesive sheet, a bonding agent such as an optical clear adhesive (OCA), a bonding layer, a bonding sheet, or the like, if necessary.

In the backlight unit 10, the light source 18 is disposed at a center position of a bottom surface inside the housing 14. The light source 18 is a light source for light emitted by the backlight unit 10.

Various known light sources can be used as the light source 18 as long as those light sources emit light having a wavelength that is wavelength-converted by the wavelength conversion member 16 (wavelength conversion layer 21).

Above all, a light emitting diode (LED) is suitably exemplified as the light source 18. In addition, as described above, a wavelength conversion layer formed by dispersing a pyrromethene derivative in a binder such as a resin is suitably used as the wavelength conversion layer 21 of the wavelength conversion member 16. Therefore, as the light source 18, a blue LED that emits blue light is particularly suitably used, and above all, a blue LED having a peak wavelength of 450 nm±50 nm is particularly suitably used.

In the backlight unit 10, the output of the light source 18 is not particularly limited and may be appropriately set according to the illuminance (brightness) and the like of light required for the backlight unit 10.

In addition, in the backlight unit 10, the number of light sources 18 may be one as shown in the illustrated example, or a plurality of light sources 18 may be provided.

The backlight unit 10 shown in FIG. 1 is a so-called direct type backlight unit. However, the present invention is not limited thereto, and can be suitably applied to a so-called edge light type backlight unit that uses a light guide plate.

In a case of an edge light type backlight unit, for example, the edge light type backlight unit may be configured in such a manner that one main surface of the wavelength conversion member 16 is disposed to face the light incident surface of the light guide plate, and the light source 18 is disposed on the opposite side of the light guide plate with the wavelength conversion member 16 interposed therebetween. In the edge light type backlight unit, a plurality of light sources 18 are usually disposed in the longitudinal direction of the light incident surface of the light guide plate, or a long light source is disposed so that the longitudinal direction of the light source coincides with the longitudinal direction of the light incident surface of the light guide plate.

<Barrier Film>

A barrier film may be appropriately used for the wavelength conversion member. Examples of the barrier film include inorganic oxides such as silicon oxide, aluminum oxide, titanium oxide, tantalum oxide, zinc oxide, tin oxide, indium oxide, yttrium oxide, and magnesium oxide, inorganic nitrides such as silicon nitride, aluminum nitride, titanium nitride, and silicon carbide nitride, mixtures thereof, metal oxide thin films or metal nitride thin films obtained by adding other elements to these inorganic oxides, inorganic nitrides, or mixtures thereof, and films consisting of various resins such as a polyvinyl chloride resin, an acrylic resin, a silicone resin, a melamine resin, a urethane resin, a fluororesin, and a polyvinyl alcohol resin such as a saponified product of vinyl acetate.

Examples of the resin having barrier properties suitably used for the barrier film include resins such as polyester, polyvinyl chloride, nylon, polyvinyl fluoride, polyvinylidene chloride, polyacrylonitrile, polyvinyl alcohol, and an ethylene-vinyl alcohol copolymer, and mixtures of these resins. Among them, polyvinylidene chloride, polyacrylonitrile, an ethylene-vinyl alcohol copolymer, and polyvinyl alcohol have very low oxygen permeability coefficients, so it is preferable to contain one or more of these resins. From the viewpoint of resistance to discoloration, it is more preferable to contain one or more of polyvinylidene chloride, polyvinyl alcohol, and an ethylene-vinyl alcohol copolymer, and from the viewpoint of reducing the environmental load, it is particularly preferable to contain polyvinyl alcohol or an ethylene-vinyl alcohol copolymer. These resins may be used alone or in admixture with different resins. A barrier film consisting of a single resin is more preferable from the viewpoint of uniformity and cost of the barrier film.

For example, a saponified product of polyvinyl acetate in which 98 mol % or more of an acetyl group is saponified can be used as the polyvinyl alcohol. In addition, for example, a saponified product of an ethylene-vinyl acetate copolymer having an ethylene content of 20% to 50% in which 98 mol % or more of an acetyl group is saponified can be used as the ethylene-vinyl alcohol copolymer.

In addition, a commercially available resin can be used, and a commercially available film can also be used. Specific examples of the commercially available resin and film include polyvinyl alcohol resins PVA105 and PVA117 (manufactured by Kuraray Co., Ltd.), EXCEVAL AQ-4104 (manufactured by Kuraray Co., Ltd.), and ethylene-vinyl alcohol copolymer (“EVAL” (registered trademark)) resins L171B and F171B, and film EF-XL (manufactured by Kuraray Co., Ltd.).

An antioxidant, a curing agent, a crosslinking agent, a processing and heat stabilizer, a light resistance stabilizer such as an ultraviolet absorbent, or the like may be added to the barrier film as necessary within a range that does not excessively affect the light emission and durability of the wavelength conversion layer.

The thickness of the barrier film is not particularly limited. From the viewpoint of flexibility and/or cost of the entire wavelength conversion member, the thickness of the barrier film is preferably 100 μm or less. The thickness of the barrier film is more preferably 50 μm or less, still more preferably 20 μm or less, even still more preferably 10 μm or less, and may be 1 μm or less. In this regard, from the viewpoint of ease of layer formation, the thickness of the barrier film is preferably 0.01 μm or more.

The barrier film may be provided on both sides of the wavelength conversion member, or may be provided only on one side of the wavelength conversion member. In addition, an auxiliary layer having an antireflection function, an antiglare function, an antireflection antiglare function, a hard coat function (rub resistance function), an antistatic function, an antifouling function, an electromagnetic wave shielding function, an infrared cut function, an ultraviolet cut function, a polarization function, a toning function, or the like may be provided depending on the required functions of the wavelength conversion member.

<Organic Layer>

The wavelength conversion member may be composed of only a substrate and a wavelength conversion layer or may be composed of only a substrate, a wavelength conversion layer, and a barrier film, and may have a configuration having one or more layers. An example of such a layer is an organic layer. The “organic layer” is a layer containing an organic substance as a main component. The organic layer can be a layer having an organic substance content of 50% by mass or more, 60% by mass or more, 70% by mass or more, 80% by mass or more, 90% by mass or more, 95% by mass or more, or 99% by mass or more. Alternatively, the organic layer can be a layer composed of only an organic substance. Here, the layer composed of only an organic substance refers to a layer containing only an organic substance, excluding impurities that are unavoidably incorporated during the production process. The organic layer may contain only one type of organic substance, or may contain two or more types of organic substances.

For the organic layer, reference can be made to paragraphs [0020] to [0042] of JP2007-290369A and paragraphs [0074] to [0105] of JP2005-096108A. In one embodiment, the organic layer can contain a cardo polymer. This leads to an increase in the adhesion to a layer adjacent to the organic layer, particularly the adhesion to an inorganic layer, which is preferable. For details of the cardo polymer, reference can be made to paragraphs [0085] to [0095] of JP2005-096108A.

In addition, an organic layer containing a (meth)acrylamide compound is also preferable as the organic layer. It is preferable to provide the organic layer containing a (meth)acrylamide compound between the barrier film and the wavelength conversion layer from the viewpoint of increasing the adhesion between these layers. In the present invention and the present specification, the “(meth)acrylamide compound” refers to a compound containing one or more (meth)acrylamide groups in one molecule. The “(meth)acrylamide group” is used to indicate one or both of an acrylamide group and a methacrylamide group. The acrylamide group is a monovalent group represented by “CH₂═CH—(C═O)—NH—”, and the methacrylamide group is a monovalent group represented by “CH₂═C(CH₃)—(C═O)—NH—”. The functionality in the “(meth)acrylamide compound” refers to the number of (meth)acrylamide groups contained in one molecule of this compound. With regard to the (meth)acrylamide compound, the “monofunctional” refers to that the number of (meth)acrylamide groups contained in one molecule is one, and the “polyfunctional” refers to that the number of (meth)acrylamide groups contained in one molecule is two or more. The (meth)acrylamide compound is preferably a polyfunctional (meth)acrylamide compound and more preferably a difunctional to hexafunctional (meth)acrylamide compound. For specific examples of the (meth)acrylamide compound, reference can be made to, for example, paragraphs [0069] and [0070] of WO2019/004431A.

The organic layer containing a (meth)acrylamide compound can be formed of a polymerizable composition containing a (meth)acrylamide compound. The (meth)acrylamide compound is a polymerizable compound, and the polymerizable composition can contain one or more (meth)acrylamide compounds as the polymerizable compound. A known polymerization initiator can be contained in the polymerizable composition. The polymerization initiator is not particularly limited, and reference can be made to, for example, paragraph [0079] of WO2019/004431A.

The organic layer can be formed on the surface of the barrier film, on the surface of the substrate, or on the surface of the wavelength conversion layer by a known method as a film forming method using a polymerizable composition. The thickness of the organic layer is preferably in a range of 0.05 to 10.00 μm and more preferably in a range of 0.50 to 5.00 μm.

### EXAMPLES

Hereinafter, the present invention will be described in more detail with reference to Examples. The materials, amounts used, ratios, treatment details, treatment procedures, and the like shown in the Examples below can be changed as appropriate without departing from the spirit of the present invention. Therefore, the scope of the present invention should not be construed as being limited by the specific examples described below.

### Example A1

(Preparation of Composition for Forming Wavelength Conversion Layer)

A light scattering particle dispersion 1 of silicone resin particles (TOSPEARL 120, manufactured by Momentive Performance Materials Inc., an average particle diameter: 2.0 μm) as light scattering particles was prepared using toluene as a solvent. The concentration of solid contents of the light scattering particle dispersion 1 was 30% by mass.

0.25 parts by mass of pyrromethene derivative G-1, 0.3 parts by mass of pyrromethene derivative R-1, 20 parts by mass of the light scattering particle dispersion 1, and 300 parts by mass of toluene as a solvent were mixed with respect to 100 parts by mass of polymethyl methacrylate (PMMA, manufactured by Kuraray Co., Ltd.) as a binder resin. Then, the mixture was stirred and defoamed for 20 minutes at 300 revolutions per minute (rpm) using a planetary stirring and defoaming device “MAZERUSTAR” KK-400 (manufactured by Kurabo Industries Ltd.) to obtain a composition 1 for forming a wavelength conversion layer.

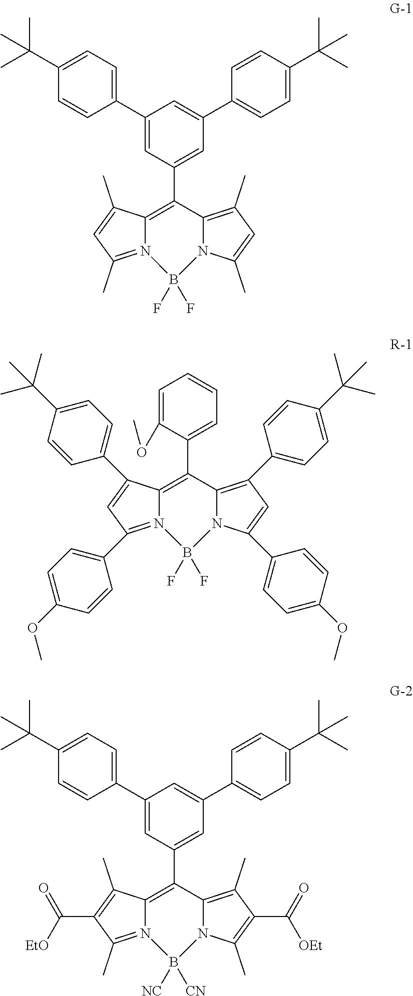

<Preparation of Wavelength Conversion Member A1>

Two PET films (COSMOSHINE A4300, manufactured by Toyobo Co., Ltd.) having a thickness of 50 μm were prepared as a substrate.

The prepared composition 1 for forming a wavelength conversion layer was applied onto one surface of one of the substrates by a die coater. Next, the composition 1 for forming a wavelength conversion layer was dried in a heating furnace having an internal temperature of 95° C. for 30 minutes to form a wavelength conversion layer A1 on the substrate. The thickness of the formed wavelength conversion layer was 22 μm.

The other substrate (PET film) was laminated on the formed wavelength conversion layer A1 and bonded with a pressure sensitive adhesive (8172CL, manufactured by 3M Company), whereby the wavelength conversion layer was sandwiched between the two substrates to prepare a wavelength conversion member as shown in FIG. 2.

The amount of the light scattering particle dispersion 1 added to the composition 1 was adjusted so that the haze of the wavelength conversion member A1 was 90%. The haze of the obtained wavelength conversion member 1 was measured in accordance with JIS K 7136:2000 using a haze meter NDH2000 (manufactured by Nippon Denshoku Industries Co., Ltd.).

### Example A2

A wavelength conversion member A2 on which a wavelength conversion layer A2 was formed was prepared in the same manner as in Example A1, except that, in Example A1, the pyrromethene derivative G-2 was used instead of the pyrromethene derivative G-1. The haze of the wavelength conversion member A2 was measured in the same manner as in Example A1, and a result of 90% was obtained.

### Example A3

A wavelength conversion member A3 was prepared in the same manner as in Example A1, except that the light scattering particles were changed from silicone resin particles to benzoguanamine-formaldehyde condensate particles (EPOSTAR MS, manufactured by Nippon Shokubai Co., Ltd., average particle diameter: 2.0 μm). The haze of the wavelength conversion member A3 was measured in the same manner as in Example A1, and a result of 95% was obtained.

### Example A4

A wavelength conversion member A4 was prepared in the same manner as in Example A1, except that the light scattering particles were changed from silicone resin particles to rutile type titanium oxide particles (D-918, manufactured by Sakai Chemical Industry Co., Ltd., average particle diameter: 0.26 μm). The haze of the wavelength conversion member A4 was measured in the same manner as in Example A1, and a result of 90% was obtained.

### Example B1

A wavelength conversion member B1 was prepared in the same manner as in Example A1, except that, in Example A1, the amount of the light scattering particles added was adjusted so that the haze of the wavelength conversion member was 70%.

### Example B2

A wavelength conversion member B2 was prepared in the same manner as in Example A1, except that the light scattering particles were not added in Example Al.

<Measurement of Initial Brightness>

A commercially available tablet terminal (trade name “Kindle (registered trademark) Fire HDX 7”, manufactured by Amazon.com, Inc.) provided with a blue light source in a backlight unit was disassembled, and the backlight unit was taken out. The wavelength conversion member of each of Examples cut into a rectangular shape (50×50 mm) was incorporated instead of the wavelength conversion member quantum dot enhancement film (QDEF) incorporated in the backlight unit. A backlight unit was prepared in this manner.

The prepared backlight unit was turned on so that the entire surface was displayed in white. An initial brightness value Y0 (cd/m²) was measured using a brightness meter (SR3, manufactured by Topcon Corporation) installed at a position of 520 mm in a direction perpendicular to the surface of the light guide plate, and evaluated based on the following evaluation standards.
Evaluation Standard

A: Y0≥530

B: 530>Y0≥515

C: 515>Y0≥500

D: 500>Y0

TABLE 1

| | | | Light scattering particle | | | |
|---|---|---|---|---|---|---|
| | | | | Average | | |
| | | | | particle | | |
| | Pyrromethene | | | diameter | Haze | Evaluation |
| | derivative | | Material | [μm] | [%] | Brightness |
| Example | G-1 | R-1 | Silicone resin | 2.0 | 90 | A |
| A1 | | | | | | |
| Example | G-2 | R-1 | Silicone resin | 2.0 | 90 | A |
| A2 | | | | | | |
| Example | G-1 | R-1 | Benzoguanamine- | 2.0 | 95 | A |
| A3 | | | formaldehyde | | | |
| | | | condensate | | | |
| | | | particle | | | |
| Example | G-1 | R-1 | Rutile type | 0.26 | 90 | A |
| A4 | | | titanium oxide | | | |
| | | | particle | | | |
| Example | G-1 | R-1 | Silicone resin | 2.0 | 70 | B |
| B1 | | | | | | |
| Example | G-1 | R-1 | — | — | 1.0 | B |
| B2 | | | | | | |

The wavelength conversion member of each of the foregoing Examples contains pyrromethene derivatives having different luminescence wavelength ranges in the same layer. From the results shown in Table 1, it can be seen that the haze value of the wavelength conversion member can be increased by including light scattering particles in such a layer, and the brightness of white light is favorable in Example A1 to Example A4, in which the haze value is 80% or more.

### Example A5

<Preparation of Composition for Forming Wavelength Conversion Layer>

0.40 parts by mass of pyrromethene derivative G-1, 0.01 parts by mass of pyrromethene derivative R-1, 2.5 parts by mass of alumina-coated titanium oxide particles with organic surface treatment (Ti-pure R-706, manufactured by The Chemours Company, average particle diameter: 0.36 μm) as light scattering particles, and 150 parts by mass of toluene and 150 parts by mass of methyl ethyl ketone as solvents were mixed with respect to 100 parts by mass of an acrylic resin (OLYCOX KC-7000F, manufactured by Kyoeisha Chemical Co., Ltd., weight-average molecular weight=40,000, Tg=56° C., SP value=9.9 (cal/cm³)^{0.5}) as a binder resin. Then, the mixture was stirred and defoamed for 60 minutes at 300 rpm using a planetary stirring and defoaming device “MAZERUSTAR” KK-400 (manufactured by Kurabo Industries Ltd.) to obtain a composition for forming a wavelength conversion layer.

<Preparation of Wavelength Conversion Member A5>

A PET film having a thickness of 100 μm (COSMOSHINE A4360, manufactured by Toyobo Co., Ltd., arithmetic average roughness Ra=0.05 μm, oxygen permeability=10.1 cc/(m²·day·atm) (under conditions of atmospheric temperature of 25° C. and relative humidity of 60%)) was prepared as one substrate 22 and the other substrate 22.

The prepared composition for forming a wavelength conversion layer was applied onto one surface of one of the substrates 22 by a bar coater (bar number #30). Next, the composition for forming a wavelength conversion layer was dried in a heating furnace having an internal temperature of 100° C. for 10 minutes to form a wavelength conversion layer 21 on one of the substrates 22. The thickness of the formed wavelength conversion layer was 21 μm.

The other substrate 22 (PET film) was laminated on the formed wavelength conversion layer 21 and bonded with a pressure sensitive adhesive (8172CL, manufactured by 3M Company), whereby the wavelength conversion layer was sandwiched between the two substrates to prepare a wavelength conversion member A5 as shown in FIG. 2.

<Measurement of Inside Haze>

The prepared wavelength conversion member A5 was cut into a size of 40 mm×40 mm, a few drops of glycerin (model number: 50373, manufactured by Tokyo Chemical Industry Co., Ltd.) were added dropwise onto both surfaces of the wavelength conversion member, and the wavelength conversion member was sandwiched between two glass plates having a thickness of 1 mm (microslide glass product number: S 9111, manufactured by Matsunami Glass Ind., Ltd.) from both sides. The wavelength conversion member having both surfaces sandwiched between the glass plates was optically completely brought into close contact with the two glass plates, and in this state, the haze (Ha) was obtained by carrying out haze measurement in accordance with JIS K 7136:2000, using a haze meter NDH-2000 (manufactured by Nippon Denshoku Industries Co., Ltd.) under the conditions of an atmospheric temperature of 25° C. and a relative humidity of 60%. Next, only a few drops of glycerin were added dropwise and sandwiched between two glass plates, and the glass haze (Hb) was measured. Then, the inside haze value was calculated by subtracting the value of the glass haze (Hb) from the value of the haze (Ha). The inside haze of the wavelength conversion member A5 was 48%.

<Measurement of Outside Haze>

The haze of the substrate 22 was measured in accordance with JIS K 7136 using a haze meter NDH2000 (manufactured by Nippon Denshoku Industries Co., Ltd.), and the obtained value was taken as the outside haze value of the substrate of the wavelength conversion member A5. The inside haze of the wavelength conversion member and the outside haze of the substrate were the values shown in the table which will be given later.

<Color Conversion Efficiency>

For Example A5 and the following Examples, the color conversion efficiency of the wavelength conversion member was evaluated by the following method.

In the measurement of the color conversion efficiency, a current of 30 mA was passed through a planar light emitting device with a wavelength conversion member and a prism sheet mounted on the planar light emitting device equipped with a blue LED element having an emission peak wavelength of 447 nm to turn on the blue LED element, and the emission spectrum was measured using a spectroradiometer (CS-1000, manufactured by Konica Minolta, Inc.). Subsequently, the color conversion efficiency was obtained from the following expression and evaluated based on the following evaluation standards.

Color conversion efficiency (BE) [%]=(IG+IR)/(I0−IB)×100

I0: number of photons at 400 to 500 nm with no wavelength conversion member mounted

IB: number of photons at 400 to 500 nm with a wavelength conversion member mounted

IG: number of photons at 500 to 580 nm with a wavelength conversion member mounted

IR: number of photons at 580 to 750 nm with a wavelength conversion member mounted
Evaluation Standards

A: BE≥80%

B: 80%>BE≥70%

C: 70%>BE≥60%

D: 60%>BE

<Durability>

A commercially available tablet terminal (trade name “Kindle (registered trademark) Fire HDX 7”, manufactured by Amazon.com, Inc.) provided with a blue light source in a backlight unit was disassembled, and the backlight unit was taken out. The wavelength conversion member of each of Example A5 or the following Examples cut into a rectangular shape (50×50 mm) was incorporated instead of the wavelength conversion member Quantum Dot Enhancement Film (QDEF) incorporated in the backlight unit. A backlight unit was prepared in this manner.

The prepared backlight unit was turned on so that the entire surface was displayed in white, and the initial brightness value Y0 (cd/m²) was measured using a brightness meter (SR3, manufactured by Topcon Corporation) installed at a position of 520 mm in a direction perpendicular to the surface of the light guide plate.

The backlight unit was turned on for 1000 hours as it was from the measurement of the initial brightness, the brightness was measured in the same manner, and the obtained value was taken as a brightness value Y1 after the test.

From the initial brightness value Y0 and the brightness value Y1 after the test, the durability [%] was calculated by the following expression and evaluated based on the following evaluation standards.

Durability [%]=(Y1/Y0)×100
Evaluation Standards

A: durability≥95%

B: 95>durability≥90%

C: 90>durability≥80%

D: durability<80%

### Example A6

A wavelength conversion member A6 was prepared in the same manner as in Example A5, except that, in Example A5, the amount of the light scattering particles added was changed to 5.0 parts by mass. The inside haze of the wavelength conversion member and the outside haze of the substrate were the values shown in the table which will be given later.

### Example A7

A wavelength conversion member A7 was prepared in the same manner as in Example A5, except that, in Example A5, the light scattering particles were changed to alumina-coated titanium oxide (CR-60, manufactured by Ishihara Sangyo Kaisha, Ltd., average particle diameter: 0.21 μm). The inside haze of the wavelength conversion member and the outside haze of the substrate were the values shown in the table which will be given later.

### Example A8

A wavelength conversion member A8 was prepared in the same manner as in Example A7, except that, in Example A7, 0.02 parts by mass of a polymer dispersant for light scattering particles (AJISPER PB-821, manufactured by Ajinomoto Fine-Techno Co., Inc.) was added to the composition for forming a wavelength conversion layer. The inside haze of the wavelength conversion member and the outside haze of the substrate were the values shown in the table which will be given later.

### Example A9

A wavelength conversion member A9 was prepared in the same manner as in Example A5, except that, in Example A5, the light scattering particles were changed to aluminum oxide (ADVANCED ALUMINA AA-0.5, manufactured by Sumitomo Chemical Co., Ltd., average particle diameter: 0.5 μm), and 0.1 parts by mass of a polymer dispersant for light scattering particles (DISPERBYK-106, manufactured by BYK-Chemie GmbH) was added. The inside haze of the wavelength conversion member and the outside haze of the substrate were the values shown in the table which will be given later.

### Example A10

A wavelength conversion member A10 was prepared in the same manner as in Example A9, except that, in Example A9, the light scattering particles were changed to aluminum oxide (ADVANCED ALUMINA AA-1.5, manufactured by Sumitomo Chemical Co., Ltd., average particle diameter: 1.5 μm). The inside haze of the wavelength conversion member and the outside haze of the substrate were the values shown in the table which will be given later.

### Example A11

A wavelength conversion member A11 was prepared in the same manner as in Example A5, except that, in Example A5, the light scattering particles were changed to 20 parts by mass of silica (SEAHOSTAR KE-P50, manufactured by Nippon Shokubai Co., Ltd., average particle diameter: 0.5 μm). The inside haze of the wavelength conversion member and the outside haze of the substrate were the values shown in the table which will be given later.

### Example A12

A wavelength conversion member A12 was prepared in the same manner as in Example A5, except that, in Example A5, no light scattering particles were added to the composition for forming a wavelength conversion layer, and one of the substrates 22 was changed to a light diffusion film D171 (manufactured by Tsujiden Co., Ltd., thickness: 120 arithmetic average roughness Ra=1.8 μm). As the other substrate 22, a PET film (COSMOSHINE A4360, manufactured by Toyobo Co., Ltd.) was used in the same manner as in Example A5. The inside haze of the wavelength conversion member and the outside haze of the substrate were the values shown in the table which will be given later.

### Example A13

A wavelength conversion member A13 was prepared in the same manner as in Example A5, except that, in Example A5, one of the substrates 22 was changed to a light diffusion film D171 (manufactured by Tsujiden Co., Ltd., thickness: 120 arithmetic average roughness Ra=1.8 μm). As the other substrate 22, a PET film (COSMOSHINE A4360, manufactured by Toyobo Co., Ltd.) was used in the same manner as in Example A5. The inside haze of the wavelength conversion member and the outside haze of the substrate were the values shown in the table which will be given later.

### Example A14

A wavelength conversion member A14 was prepared in the same manner as in Example A5, except that, in Example A5, the light scattering particles were changed to hydrogen dimethicone-coated rutile type titanium oxide (SILKY TOUCH TITANIUM OXIDE ST-710EC, manufactured by Titan Kogyo, Ltd., average particle diameter: 0.3 μm). The inside haze of the wavelength conversion member and the outside haze of the substrate were the values shown in the table which will be given later.

### Example B3

A wavelength conversion member B3 was prepared in the same manner as in Example A12, except that, in Example A12, one of the substrates 22 was changed to a light diffusion film LIGHT-UP SP6F (manufactured by Kimoto Co., Ltd., thickness: 114 arithmetic average roughness Ra=3.5 μm). As the other substrate 22, a PET film (COSMOSHINE A4360, manufactured by Toyobo Co., Ltd.) was used in the same manner as in Example A12. The inside haze of the wavelength conversion member and the outside haze of the substrate were the values shown in the table which will be given later.

### Example B4

A wavelength conversion member B4 was prepared in the same manner as in Example A12, except that, in Example A12, one of the substrates 22 was changed to a light diffusion film LIGHT-UP SXE (manufactured by Kimoto Co., Ltd., thickness: 115 arithmetic average roughness Ra=7.2 μm). As the other substrate 22, a PET film (COSMOSHINE A4360, manufactured by Toyobo Co., Ltd.) was used. The inside haze of the wavelength conversion member and the outside haze of the substrate were the values shown in the table which will be given later.

### Example A15

A wavelength conversion member A15 was prepared in the same manner as in Example A5, except that, in Example A5, the binder resin was changed to the ester resin T11 (SP value =10.7 (cal/cm³)^{0.5}). The inside haze of the wavelength conversion member and the outside haze of the substrate were the values shown in the table which will be given later.

### Example A16

A wavelength conversion member A16 was prepared in the same manner as in Example A5, except that, in Example A5, the binder resin was changed to the cycloolefin resin T21 (SP value=8.9 (cal/cm³)^{0.5}). The inside haze of the wavelength conversion member and the outside haze of the substrate were the values shown in the table which will be given later.

### Example A17

A wavelength conversion member A17 was prepared in the same manner as in Example A5, except that, in Example A5, the binder resin was changed to the phenoxy resin T31 (SP value=10.9 (cal/cm³)^{0.5}). The inside haze of the wavelength conversion member and the outside haze of the substrate were the values shown in the table which will be given later.

From the results shown in Table 2 below, it can be seen that the wavelength conversion members of Example A5 to Example A13 have an inside haze of 30% or more and an outside haze of 50% or less, satisfy a relationship of inside haze≥outside haze, and have favorable color conversion efficiency, that is, favorable brightness of white light due to high color purity.

TABLE 2

| | Wavelength conversion layer | | | | | | | | | | | |
|---|---|---|---|---|---|---|---|---|---|---|---|---|
| | Pyrromethene | | Light scattering particle | | | | | | | | | |
| | derivative | | | | Amount | | | | | | | |
| | Green | Red | | Average | added | | | Substrate | | | Evaluation | |
| | light | light | | particle | % by | | Inside | | | Outside | Color | |
| | emittmg | emittmg | | diameter | mass/solid | | haze | | Thickness | haze | conversion | |
| | body | body | Material | [μm] | content] | Dispersant | [%] | Material | [μm] | [%] | efficiency | Durability |
| Example | G-1 | R-1 | Titanium oxide | 0.36 | 2.5 | — | 48 | PET | 100 | 1 | A | B |
| A5 | | | Ti-pure R-706 | | | | | A4360 | | | | |
| Example | G-1 | R-1 | Titanium oxide | 0.36 | 5.0 | — | 72 | PET | 100 | 1 | B | B |
| A6 | | | Ti-pure R-706 | | | | | A4360 | | | | |
| Example | G-1 | R-1 | Titanium oxide | 0.21 | 2.0 | — | 31 | PET | 100 | 1 | B | B |
| A7 | | | CR-60 | | | | | A4360 | | | | |
| Example | G-1 | R-1 | Titanium oxide | 0.21 | 2.0 | AJISPER | 40 | PET | 100 | 1 | A | B |
| A8 | | | CR-60 | | | PB-821 | | A4360 | | | | |
| Example | G-1 | R-1 | Aluminum oxide | 0.5 | 10.0 | DISPERBYK- | 56 | PET | 100 | 1 | B | A |
| A9 | | | AA-0.5 | | | 106 | | A4360 | | | | |
| Example | G-1 | R-1 | Aluminum oxide | 1.5 | 10.0 | DISPERBYK- | 51 | PET | 100 | 1 | A | A |
| A10 | | | AA-1.5 | | | 106 | | A4360 | | | | |
| Example | G-1 | R-1 | Silica | 0.5 | 20.0 | — | 43 | PET | 100 | 1 | A | A |
| A11 | | | SEAHOSTAR | | | | | A4360 | | | | |
| | | | KE-P50 | | | | | | | | | |
| Example | G-1 | R-1 | — | — | — | — | 2 | D171 | 120 | 35 | B | A |
| A12 | | | | | | | | | | | | |
| Example | G-1 | R-1 | Titanium oxide | 0.4 | 2.5 | — | 48 | D171 | 120 | 35 | A | B |
| A13 | | | Ti-pure R-706 | | | | | | | | | |
| Example | G-1 | R-1 | Titanium oxide | 0.3 | 2.5 | — | 45 | PET | 100 | 1 | A | C |
| A14 | | | SILKY TOUCH | | | | | A4360 | | | | |
| | | | ST-710EC | | | | | | | | | |
| Example | G-1 | R-1 | — | — | — | — | 2 | LIGHT-UP | 114 | 67 | C | A |
| B3 | | | | | | | | SP6F | | | | |
| Example | G-1 | R-1 | — | — | — | — | 2 | LIGHT-UP | 115 | 90 | D | A |
| B4 | | | | | | | | SXE | | | | |

| | Wavelength conversion layer | | | | | | |
|---|---|---|---|---|---|---|---|
| | Pyrommethene | | | | Light scattering particle | | |
| | derivative | | | | | | Amount |
| | Green | | | | | Average | added |
| | light | Red light | | | | particle | [1% by |
| | emitting | emitting | | SP value | | diameter | mass/solid |
| | body | body | Binder | [(cal/cm³)^{0.5}] | Material | [μm] | content] |
| Example | G-1 | R-1 | Acrylic | 99 | Titanium | 0.36 | 2.5 |
| A5 | | | resin | | oxide | | |
| | | | | | Ti-pure | | |
| | | | | | R-706 | | |
| Example | G-1 | R-1 | Polyester | 10.7 | Titanium | 0.36 | 2.5 |
| A15 | | | resin | | oxide | | |
| | | | | | Ti-pure | | |
| | | | | | R-706 | | |
| Example | G-1 | R-1 | Cyclcolefin | 8.9 | Titanium | 0.36 | 2.5 |
| A16 | | | resin | | oxide | | |
| | | | | | Ti-pure | | |
| | | | | | R-706 | | |
| Example | G-1 | R-1 | Phenoxy | 10.9 | Titanium | 0.36 | 2.5 |
| A17 | | | resin | | oxide | | |
| | | | | | Ti-pure | | |
| | | | | | R-706 | | |
| | | Wavelength | | | | | |
| | Wavelength | conversion | Substrate | | | Evaluation | |
| | conversion | member | | | Outside | Color | |
| | layer | Inside haze | | Thickness | haze | conversion | |
| | Dispersant | [%] | Material | [μm] | [%] | efficiency | Durability |
| Example | — | 48 | PET | 100 | 1 | A | B |
| A5 | | | A4360 | | | | |
| Example | — | 48 | PET | 100 | 1 | A | B |
| A15 | | | A4360 | | | | |
| Example | — | 48 | PET | 100 | 1 | B | B |
| A16 | | | 44360 | | | | |
| Example | — | 48 | PET | 100 | 1 | B | B |
| A17 | | | A4360 | | | | |

One aspect of the present invention is useful in the technical field of a liquid crystal display device.

### EXPLANATION OF REFERENCES

10: backlight unit

14: housing

16: wavelength conversion member

18: light source

21: wavelength conversion layer

22: substrate

What is claimed is:

1. A wavelength conversion member comprising:
a wavelength conversion layer; and
a substrate,
wherein the wavelength conversion layer contains a pyrromethene derivative, a binder, and a light scattering particle.

2. A wavelength conversion member comprising:
a wavelength conversion layer; and
a substrate,
wherein the wavelength conversion layer contains a pyrromethene derivative, and
a haze of the wavelength conversion member is 80% or more and 99.5% or less.

3. A wavelength conversion member comprising:
a wavelength conversion layer; and
a substrate,
wherein the wavelength conversion layer contains a pyrromethene derivative,
an outside haze of the substrate is 0.5% or more and 50% or less, and
an inside haze of the wavelength conversion member is 30% or more.

4. The wavelength conversion member according to claim 3,
wherein the inside haze of the wavelength conversion member and the outside haze of the substrate satisfy a relationship of inside haze≥outside haze.

5. The wavelength conversion member according to claim 1,
wherein a diameter R of the light scattering particle is 0.1 μm or more.

6. The wavelength conversion member according to claim 1,
wherein the wavelength conversion member contains, in the same wavelength conversion layer,
a pyrromethene derivative exhibiting light emission by using excitation light, in which a peak wavelength is observed in a region of 500 nm or more and 580 nm or less, and
a pyrromethene derivative exhibiting light emission by using excitation light, in which a peak wavelength is observed in a region of 580 nm or more and 750 nm or less.

7. The wavelength conversion member according to claim 5,
wherein the wavelength conversion member contains, in the same wavelength conversion layer,
a pyrromethene derivative exhibiting light emission by using excitation light, in which a peak wavelength is observed in a region of 500 nm or more and 580 nm or less, and
a pyrromethene derivative exhibiting light emission by using excitation light, in which a peak wavelength is observed in a region of 580 nm or more and 750 nm or less.

8. The wavelength conversion member according to claim 2,
wherein a diameter R of the light scattering particle is 0.1 μm or more.

9. The wavelength conversion member according to claim 2,
wherein the wavelength conversion member contains, in the same wavelength conversion layer,
a pyrromethene derivative exhibiting light emission by using excitation light, in which a peak wavelength is observed in a region of 500 nm or more and 580 nm or less, and
a pyrromethene derivative exhibiting light emission by using excitation light, in which a peak wavelength is observed in a region of 580 nm or more and 750 nm or less.

10. The wavelength conversion member according to claim 8,
wherein the wavelength conversion member contains, in the same wavelength conversion layer,
a pyrromethene derivative exhibiting light emission by using excitation light, in which a peak wavelength is observed in a region of 500 nm or more and 580 nm or less, and
a pyrromethene derivative exhibiting light emission by using excitation light, in which a peak wavelength is observed in a region of 580 nm or more and 750 nm or less.

11. The wavelength conversion member according to claim 3,
wherein a diameter R of the light scattering particle is 0.1 μm or more.

12. The wavelength conversion member according to claim 3,
wherein the wavelength conversion member contains, in the same wavelength conversion layer,
a pyrromethene derivative exhibiting light emission by using excitation light, in which a peak wavelength is observed in a region of 500 nm or more and 580 nm or less, and
a pyrromethene derivative exhibiting light emission by using excitation light, in which a peak wavelength is observed in a region of 580 nm or more and 750 nm or less.

13. The wavelength conversion member according to claim 11,
wherein the wavelength conversion member contains, in the same wavelength conversion layer,
a pyrromethene derivative exhibiting light emission by using excitation light, in which a peak wavelength is observed in a region of 500 nm or more and 580 nm or less, and
a pyrromethene derivative exhibiting light emission by using excitation light, in which a peak wavelength is observed in a region of 580 nm or more and 750 nm or less.

14. A light emitting device comprising:
the wavelength conversion member according to claim 1; and
a light source.

15. The light emitting device according to claim 14,
wherein the light source is selected from the group consisting of a blue light emitting diode and an ultraviolet light emitting diode.

16. A liquid crystal display device comprising:
the light emitting device according to claim 14; and
a liquid crystal cell.

17. A light emitting device comprising:
the wavelength conversion member according to claim 2; and
a light source.

18. A liquid crystal display device comprising:
the light emitting device according to claim 17; and
a liquid crystal cell.

19. A light emitting device comprising:
the wavelength conversion member according to claim 3; and
a light source.

20. A liquid crystal display device comprising:
the light emitting device according to claim 19; and
a liquid crystal cell.
